(19) United States
(12) Patent Application Publication
(10) Pub. No.: US 2016/0179422 A1
(43) Pub. Date: Jun. 23, 2016

(54) METHOD OF PERFORMING GARBAGE COLLECTION AND RAID STORAGE SYSTEM ADOPTING THE SAME

(71) Applicant: SAMSUNG ELECTRONICS CO., LTD., SUWON-SI (KR)

(72) Inventor: JU-PYUNG LEE, YEONSU-GU (KR)

(21) Appl. No.: 14/962,913

(22) Filed: Dec. 8, 2015

(30) Foreign Application Priority Data
Dec. 19, 2014 (KR) 10-2014-0184963

(51) Int. Cl. G06F 3/06

(52) U.S. Cl. CPC G06F 3/0619; G06F 3/0689; G06F 3/0665; G06F 3/0688; G06F 3/0655

(57) ABSTRACT

Provided are a method of performing garbage collection and a redundant array of independent disks (RAID) storage system to which the method is applied. The method includes selecting a victim stripe for performing the garbage collection in the RAID storage system based on a ratio of valid pages. Valid pages included in the victim stripe are copied to a non-volatile cache memory. Garbage collection is performed with respect to the victim stripe by using data copied to the non-volatile cache memory.

### CROSS-REFERENCE TO RELATED APPLICATIONS

This application claims the benefit of Korean Patent Application No. 10-2014-0184963, filed on Dec. 19, 2014, in the Korean Intellectual Property Office, the disclosure of which is incorporated herein in its entirety by reference.

### BACKGROUND

The disclosure relates to a method of processing data in a storage system, and more particularly, to a method of performing garbage collection and a redundant array of independent disks (RAID) storage system to which the method is applied.

A RAID is a technology of distributing data to be stored in a plurality of hard disk devices. Due to technical developments, solid state drives (SSDs) may be used instead of the hard disk devices. Research into ensuring data reliability even if there is a defect in some of the SSDs configuring a storage system, to which the RAID system is applied, and reducing a write amplification factor (WAF) has been necessarily conducted.

### SUMMARY

The disclosure provides a garbage collection operating method for ensuring reliability of data that needs to be migrated according to a garbage collection operation.

The disclosure provides a redundant array of independent disks (RAID) storage system capable of performing data processing for ensuring reliability of data that needs to be migrated according to a garbage collection operation.

According to an aspect of the disclosure, there is provided a method of performing a garbage collection operation, the method including: selecting a victim stripe for performing the garbage collection in a redundant array of independent disks (RAID) storage system based on a ratio of valid pages; copying valid pages included in the victim stripe to a non-volatile cache memory; and performing the garbage collection with respect to the victim stripe by using data copied to the non-volatile cache memory.

The selecting of the victim stripe may be performed based on a lower order of valid page ratios in stripes.

The copying of the valid pages to the non-volatile cache memory may include copying valid pages included in memory blocks of a solid state drive (SSD) forming the victim stripe that is selected in a log-structured RAID storage system based on SSDs, to the non-volatile cache memory.

The performing of the garbage collection may include: erasing parity information included in the victim stripe; copying the valid pages included in the victim stripe to memory blocks that are to form a new stripe; and performing an erasing operation on the memory blocks of the victim stripe, which store the valid pages that have been copied.

The memory blocks that are to form the new stripe may be allocated as storage regions, to which the valid pages included in the victim stripe for the garbage collection are copied.

The copying of the valid pages to the memory blocks for configuring the new stripe may include copying the valid pages to a memory block that is to form the new stripe in an SSD that is the same as the SSD including the valid pages of the victim stripe in the RAID storage system.

The copying of the valid pages to the memory blocks for configuring the new stripe may include distributing the valid pages included in the victim stripe evenly to the memory blocks that are to form the new stripe.

The copying of the valid pages to the memory block for configuring the new stripe may include: calculating an average value of the valid pages by dividing a total number of the valid pages included in the victim stripe by the number of memory blocks, except for a memory block storing the parity information, from among the memory blocks that form a stripe; copying the valid pages in each of the memory blocks configuring the victim stripe to new memory blocks of the SSD that is the same as the SSD including the valid pages in the range of less than or equal to the average value; and copying remaining valid pages in the victim stripe to a memory block for forming the new stripe so that the valid pages may be evenly stored in memory blocks of SSDs for forming the new stripe.

The performing of the garbage collection may include: calculating parity information for data copied to the non-volatile cache memory; and copying the parity information to a memory block that is to form the new stripe.

If a request for reading a valid page included in the victim stripe is transmitted to the RAID storage system during the garbage collection, the valid page may be read from the non-volatile cache memory.

According to an aspect of the disclosure, there is provided a redundant array of independent disk (RAID) storage system including: a plurality of storage devices, each including memory blocks for storing data; a non-volatile random access memory (NVRAM); and a RAID controller for controlling the plurality of storage devices based on a log-structured RAID environment, wherein the RAID controller performs a control operation for copying valid pages of the plurality of storage devices included in a victim stripe for garbage collection to the NVRAM, and performs a garbage collection control operation by using data copied to the NVRAM.

The plurality of storage devices may include a plurality of solid state drives (SSDs).

The NVRAM may include: a first cache region for storing data to be written in the plurality of storage devices in units of stripes; and a second cache region to which the valid pages of the plurality of storage devices included in the victim stripe are copied.

The garbage collection control operation may include a control operation for erasing a memory block storing parity information included in the victim stripe, a control operation for copying the valid pages included in the victim stripe to memory blocks that are to form a new stripe, and a control operation for erasing the memory blocks of the victim stripe, in which the valid pages copied to the memory blocks that are to form the new stripe.

The garbage collection control operation may further include a control operation of calculating parity information for data copied to the NVRAM and copying the parity information to a memory block for configuring the new stripe.

When a request for reading a valid page included in the victim stripe is transmitted during the garbage collection control operation, the RAID controller may read the valid page from the NVRAM.

According to an aspect of the disclosure, there is provided a redundant array of independent disks (RAID) storage system including: a plurality of solid state drives (SSDs), each comprising a non-volatile random access memory (NVRAM) cache region and a flash memory storage region; and a RAID controller for controlling the plurality of SSDs based on a log-structured RAID environment. The RAID controller performs control operations for copying valid pages written in the flash memory storage regions included in a victim stripe for garbage collection to the NVRAM cache region and performs a garbage collection control operation by using data copied to the NVRAM.

The RAID controller may perform a control operation for copying valid pages written in the flash memory storage regions of the plurality of SSDs included in the victim stripe for the garbage collection to the NVRAM cache regions of different SSDs.

The RAID controller may perform control operations for erasing a memory block of the flash memory storage region storing parity information included in the victim stripe, for copying valid pages of the flash storage regions included in the victim stripe to new memory blocks of the flash memory storage regions, erasing the memory blocks of the victim stripe, which store the valid pages copied to the new memory blocks, and copying parity information for data copied to the NVRAM cache region to a memory block for configuring a new stripe.

The NVRAM cache region may be formed in a dynamic RAM (DRAM) by supplying electric power to the DRAM included in each of the SSDs by using a battery or a capacitor.

According to another aspect of the disclosure, there is provided a method of recovering pages constituting a unit stripe of memory, the method executed by a processor of a memory controller in a log-structured storage system of a redundant array of independent disks (RAID) storage system. The method includes: selecting, among multiple stripes that each comprises first and second memory blocks, a stripe having an invalid pages-to-total pages ratio exceeding a threshold value; copying valid pages of the selected stripe to a nonvolatile cache; and erasing data stored in invalid pages and the valid pages of the selected stripe.

The method may further include: receiving, from a host device, a request for a particular valid page of the selected stripe; retrieving the copy of the particular page from the nonvolatile cache; and communicating the retrieved copy of the particular page to the host device.

The method may further include copying the valid pages of the selected stripe to first and second memory blocks of another stripe whose pages are erased.

The method may further include, for each valid page within the first block and an associated page within the second block of the other stripe, generating a page of parity information and storing the generated page of parity information in a third memory block of the other stripe. The new locations of the valid pages copied to the other stripe and their associated parity information may be registered within an address mapping registry.

The method may further include, upon receiving from a host device a request for a particular valid page of the selected stripe prior to registering the new locations of the valid pages copied to the other stripe and their associated parity information within the address mapping registry: retrieving the copy of the particular page from the nonvolatile cache, and communicating the retrieved copy of the particular page to the host device. Upon receiving, from the host device, a request for the particular valid page of the selected stripe after registering the new locations of the valid pages copied to the other stripe and their associated parity information within the address mapping registry: retrieving the particular page from the other stripe using location information for the particular page stored within the address mapping registry, and communicating the particular page retrieved from the other stripe to the host device.

The method may further include, for each valid page erased from the first and second memory blocks of the selected stripe, erasing a corresponding page of parity information stored in a third memory block of the selected stripe.

According to another aspect of the disclosure, there is provided a redundant array of independent disks (RAID) storage apparatus comprising first and second solid state drives, a nonvolatile cache, and a control processor. The control processor: selects, among multiple stripes that each comprises first and second memory blocks, a stripe having an invalid pages-to-total pages ratio exceeding a threshold value; copies valid pages of the selected stripe to the nonvolatile cache; and erases data stored in invalid pages and the valid pages of the selected stripe. The first memory block of each stripe exists within the first solid state drive, and the second memory block of each stripe exists within the second solid state drive.

The control processor may: receive, from a host device, a request for a particular valid page of the selected stripe; retrieve the copy of the particular page from the nonvolatile cache; and communicate the retrieved copy of the particular page to the host device.

The control processor may copy valid pages of the selected stripe to first and second memory blocks of another stripe whose pages are erased.

The apparatus may further include a third solid state drive. For each valid page within the first block and an associated page within the second block of the other stripe, the control processor may generate a page of parity information and store the generated page of parity information in a third memory block of the other stripe. The control processor may register the new locations of the valid pages copied to the other stripe and their associated parity information within an address mapping registry. The third memory block of the other stripe may exist within the third solid state drive.

Upon receiving from a host device a request for a particular valid page of the selected stripe prior to registering the new locations of the valid pages copied to the other stripe and their associated parity information within the address mapping registry, the control processor may: retrieve the copy of the particular page from the nonvolatile cache, and communicate the retrieved copy of the particular page to the host device. Upon receiving from the host device a request for the particular valid page of the selected stripe after registering the new locations of the valid pages copied to the other stripe and their associated parity information within the address mapping registry, the control processor may: retrieve the particular page from the other stripe using location information for the particular page stored within the address mapping registry, and communicate the particular page retrieved from the other stripe to the host device.

The apparatus may further include a third solid state drive. For each valid page erased from the first and second memory blocks of the selected stripe, the control processor may erase a corresponding page of parity information stored in a third memory block of the selected stripe. The third memory block of the other stripe may exist within the third solid state drive.

### BRIEF DESCRIPTION OF THE DRAWINGS

Exemplary embodiments of the disclosure will be more clearly understood from the following detailed description taken in conjunction with the accompanying drawings in which:

FIG. 1 is a block diagram of a redundant array of independent disks (RAID) storage system according to an exemplary embodiment of the disclosure;

FIG. 2 is a block diagram of a RAID storage system according to another exemplary embodiment of the disclosure;

FIG. 3 is a block diagram of a RAID storage system according to another exemplary embodiment of the disclosure;

FIG. 4 is a block diagram of a RAID storage system according to another exemplary embodiment of the disclosure;

FIGS. 5A to 5C are diagrams showing examples of setting a storage region in a non-volatile random access memory (RAM) shown in FIGS. 1 to 4;

FIG. 6 is a conceptual diagram illustrating a writing operation according to a parity-based RAID method in the RAID storage system according to an exemplary embodiment of the disclosure;

FIG. 7 is a diagram illustrating a log-structured RAID method in the RAID storage system according to an exemplary embodiment of the disclosure;

FIG. 8 is a diagram illustrating an example of executing an SSD-based log-structured RAID method in the RAID storage system by using a non-volatile random access memory (NVRAM), according to an exemplary embodiment of the disclosure;

FIGS. 9A and 9B are diagrams of a writing operation performed in units of stripes in the RAID storage system according to the exemplary embodiment of the disclosure;

FIGS. 10A to 10D are conceptual diagrams illustrating processes of storing data by writing the data in the storage devices in units of memory blocks in the RAID storage system according to an exemplary embodiment of the disclosure;

FIGS. 11A to 11D are conceptual diagrams illustrating processes of storing data in the storage devices in units of pages, in the RAID storage system according to an exemplary embodiment of the disclosure;

FIGS. 12A to 12H are conceptual diagrams illustrating processes of performing a garbage collection operation in the RAID storage system according to an exemplary embodiment of the disclosure;

FIGS. 13A and 13B are conceptual diagrams illustrating examples of copying valid pages included in the victim stripe to new memory blocks, during the garbage collection operation in the RAID storage system according to an exemplary embodiment of the disclosure;

FIG. 14 is a block diagram of a solid state drive (SSD) forming the RAID storage system according to an exemplary embodiment of the disclosure;

FIG. 15 is a diagram exemplarily showing a channel and a way in the SSD of FIG. 14;

FIG. 16 is a diagram of the memory controller of FIG. 15 in more detail;

FIG. 17 is a diagram of a flash memory chip forming the memory device of FIG. 15 in detail;

FIG. 18 is a diagram of an example of a memory cell array shown in FIG. 17;

FIG. 19 is a circuit diagram exemplary showing a first memory block included in the memory cell array of FIG. 17;

FIG. 20 is a diagram of a RAID storage system according to another exemplary embodiment of the disclosure;

FIG. 21 is a block diagram of an SSD of FIG. 20;

FIG. 22 is a block diagram of a memory controller of FIG. 21 in detail;

FIG. 23 is a block diagram of the memory controller of FIG. 21 according to another exemplary embodiment;

FIGS. 24A to 24E are conceptual diagrams illustrating a stripe writing operation in the RAID storage system of FIG. 20;

FIG. 25 is a diagram of a RAID storage system according to another exemplary embodiment of the disclosure;

FIG. 26 is a block diagram of a memory controller of FIG. 25;

FIG. 27 is a block diagram of the memory controller of FIG. 25 according to another exemplary embodiment;

FIG. 28 is a diagram showing an example of forming a stripe in the RAID storage system of FIG. 25;

FIG. 29 is a diagram showing another example of forming a stripe in the RAID storage system of FIG. 25;

FIG. 30 is a flowchart of a method of performing a garbage collection operation according to an exemplary embodiment of the disclosure;

FIG. 31 is a flowchart of a process of performing the garbage collection operation of FIG. 30 in more detail;

FIG. 32 is a flowchart of a process of copying valid pages to a memory block shown in FIG. 31 in more detail; and

FIG. 33 is a flowchart showing another example of a process of performing the garbage collection operation of FIG. 30.

### DETAILED DESCRIPTION OF THE EMBODIMENTS

The disclosure will now be described more fully with reference to the accompanying drawings, in which exemplary embodiments of the disclosure are shown. This disclosure may, however, be embodied in many different forms and should not be construed as limited to the exemplary embodiments set forth herein. Rather, these embodiments are provided so that this disclosure will be thorough and complete, and will fully convey the scope of the disclosure to those of ordinary skill in the art. As the disclosure allows for various changes and numerous embodiments, particular exemplary embodiments will be illustrated in the drawings and described in detail in the written description. However, this is not intended to limit the disclosure to particular modes of practice, and it is to be appreciated that all changes, equivalents, and substitutes that do not depart from the spirit and technical scope are encompassed in the disclosure. In the description, certain detailed explanations of the related art are omitted when it is deemed that they may unnecessarily obscure the essence of the disclosure.

The terms used in the present specification are merely used to describe particular embodiments, and are not intended to limit the disclosure. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items. Expressions such as “at least one of,” when preceding a list of elements, modify the entire list of elements and do not modify the individual elements of the list.

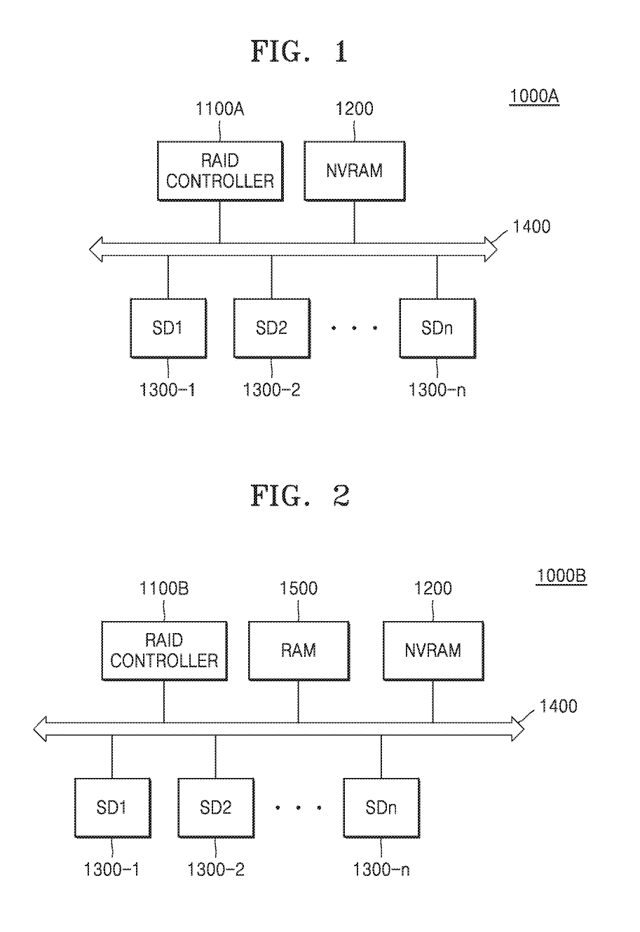

FIG. 1 is a block diagram of a redundant array of independent disks (RAID) storage system 1000A according to an exemplary embodiment of the disclosure.

Referring to FIG. 1, the RAID storage system 1000A may include a RAID controller 1100A, a non-volatile random access memory (NVRAM) 1200, a plurality of storage devices SD1 to SDn; 1300-1 to 1300-n, and a bus 1400. Components of the RAID storage system 1000A are electrically connected to one another via the bus 1400.

A RAID storage method has two types of data restoring methods, that is, a mirroring-based data restoring method and a parity-based data restoring method, when a partial storage device is defective. For example, the parity-based RAID method may be applied to the RAID storage system 1000A.

The plurality of storage devices 1300-1 to 1300-n may be formed as solid state drives (SSDs) or hard disk drives (HDDs). In the present exemplary embodiment of the disclosure, the plurality of storage devices 1300-1 to 1300-n are SSDs. Each SSD forms a storage device by using a plurality of non-volatile memory chips. For example, each SSD may form the storage device by using a plurality of flash memory chips.

The NVRAM 1200 is a RAM that is capable of storing data even if electric power is turned off. For example, the NVRAM 1200 may include phase RAM (PRAM), ferroelectric RAM (FeRAM), or magnetic RAM (MRAM). As another example, the NVRAM 1200 may be formed by dynamic RAM (DRAM) or static RAM (SRAM) that is a volatile memory, to which electric power is supplied by using a battery or a capacitor. That is, if system power is turned off, the DRAM or the SRAM may be driven by using the battery or the capacitor so that data stored in the DRAM or the SRAM is moved to the storage device that is the non-volatile storage space. According to the above method, the data stored in the DRAM or the SRAM may be maintained even if the system power is turned off

A cache region may be allocated to the NVRAM 1200 for storing data that is temporarily not protected by parity information during a garbage collection operation. Here, the data that is temporarily not protected by the parity information is referred to as orphan data. In addition, the cache region allocated to the NVRAM 1200 to store the orphan data is referred to as an orphan cache region.

For example, a cache region for storing data to be written in units of stripes to the plurality of storage devices 1300-1 to 1300-n may be allocated to the NVRAM 1200. Here, the cache region for storing the data to be written in units of stripes in the NVRAM 1200 will be referred to as a stripe cache region.

For example, the NVRAM 1200 may store mapping table information used by the RAID storage system 1000A. The mapping table information may include address mapping table information for converting a logical address to a physical address, and stripe mapping table information representing information for stripe grouping. The information for the stripe grouping may include information indicating memory blocks configuring each stripe. The stripe mapping table information may include valid page ratio information with respect to each stripe.

For example, the address mapping table information may store a physical address of a storage device corresponding to a logical address. In particular, the address mapping table information may include a number of the storage device corresponding to the logical address and the physical address of that storage device.

The RAID controller 1100A controls the plurality of storage devices 1300-1 to 1300-n based on a log-structured RAID environment. In particular, if the data written in the plurality of storage devices 1300-1 to 1300-n is updated, the RAID controller 1100A controls the RAID storage system 1000A to write the data at a new location in a log format, rather than overwrite the data. For example, the plurality of memory blocks in which the data is written in the log format and the memory block storing parity information for the data stored in the plurality of memory blocks form a stripe.

The RAID controller 1100A registers location information of the memory blocks in the storage devices 1300-1 to 1300-n, which form the stripe, to the stripe mapping table.

The RAID controller 1100A may perform the address conversion process or the stripe grouping process by using the mapping table information stored in the NVRAM 1200. In particular, the RAID controller 1100A converts the logical address into the physical address by using the address mapping table information. In addition, the RAID controller 1100A performs the garbage collection operation in units of stripes by using the mapping table information.

The RAID controller 1100A selects a victim stripe for performing the garbage collection by using the mapping table information. For example, the RAID controller 1100A determines a stripe having the lowest ratio of valid pages from among the stripes that are grouped by using the stripe mapping table information, and selects the stripe as the victim stripe.

The RAID controller 1100A performs a controlling operation to copy valid pages of the plurality of storage devices 1300-1 to 1300-n included in the victim stripe, for performing the garbage collection, to the NVRAM 1200 and performs a garbage collection control operation by using the data copied to the NVRAM 1200. In particular, the RAID controller 1100A performs a control operation for copying the valid pages in the plurality of storage devices 1300-1 to 1300-n included in the victim stripe, for performing the garbage collection, to the orphan cache region of the NVRAM 1200.

The RAID controller 1100A performs a control operation for erasing the memory blocks including the parity information included in the victim stripe, a control operation for copying the valid pages included in the victim stripe to the memory block that is to form a new stripe, and a control operation for erasing the memory block of the victim stripe, which stores the valid pages copied to the memory block that is to form the new stripe.

The RAID controller 1100A calculates parity information for the data copied to the orphan cache region in the NVRAM 1200 and copies the calculated parity information to the memory block that is to form the new stripe.

The RAID controller 1100A registers stripe grouping information for configuration of the new stripe to the stripe mapping table, with respect to the memory blocks to which the valid pages included in the victim stripe are copied, and the memory blocks to which the parity information is copied. In addition, the RAID controller 1100A deletes the stripe grouping information for the victim stripe from the stripe mapping table. Accordingly, the memory blocks included in the victim stripe become free blocks. The free block denotes an empty memory block in which data is not stored.

After deleting the memory block storing the parity information included in the victim stripe during the garbage collection operation of the RAID storage system 1000A, the valid pages written in the memory blocks included in the victim stripe may not be protected by using the parity information. That is, if there is a defect in some of the plurality of storage devices 1300-1 to 1300-n, the valid pages written in the memory block of the defective storage device in the victim stripe may not restore the data damaged by the defect using the parity information.

According to an exemplary embodiment of the disclosure, since the valid pages of the plurality of storage devices 1300-1 to 1300-n included in the victim stripe are stored in the orphan cache region of the NVRAM 1200, even if some of the plurality of storage devices 1300-1 to 1300-n have failures the valid pages written in the memory blocks of the storage devices having the failures may be restored by the data stored in the orphan cache region of the NVRAM 1200.

When a request to read the pages included in the victim stripe occurs during the garbage collection operation, the RAID controller 1100A reads data for the pages that is requested to be read from the orphan cache region of the NVRAM 1200.

For example, a request to read the pages included in the victim stripe is transmitted from an external host (not shown) to the RAID storage system 1000A during the garbage collection operation, the RAID controller 1100A reads the data for the pages that are requested to be read from the orphan cache region of the NVRAM 1200 and transmits the read data to the external host.

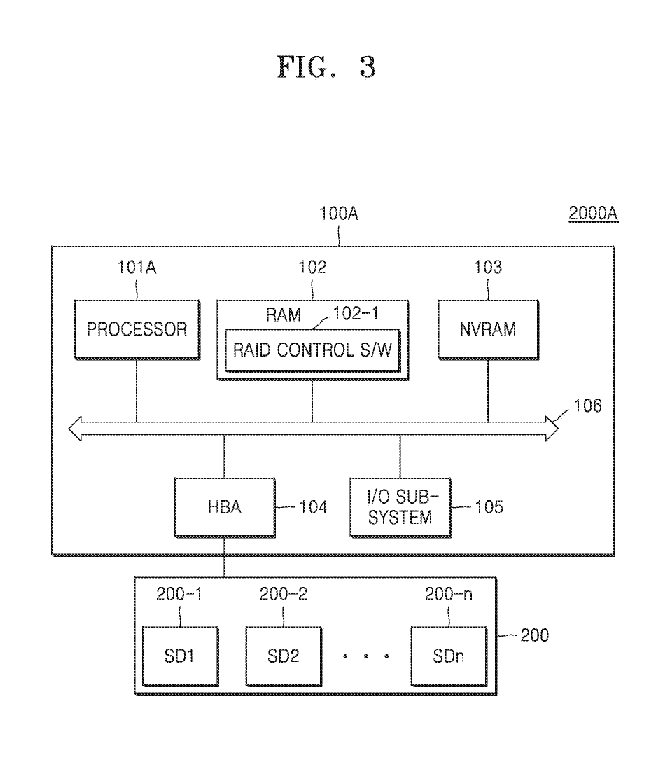

FIG. 2 is a block diagram of a RAID storage system 1000B according to another exemplary embodiment of the disclosure.

Referring to FIG. 2, the RAID storage system 1000B may include a RAID controller 1100B, the NVRAM 1200, the plurality of storage devices 1300-1 to 1300-n, the bus 1400, and a RAM 1500. Elements of the RAID storage system 1000B may be electrically connected to one another via the bus 1400.

The NVRAM 1200, the plurality of storage devices 1300-1 to 1300-n, and the bus 1400 of FIG. 2 have been already described above with reference to FIG. 1, and thus, detailed descriptions thereof will not be repeated.

The RAID storage system 1000B may additionally include the RAM 1500, unlike the RAID storage system 1000A of FIG. 1.

The RAM 1500 is a volatile memory, and may be DRAM or SRAM. The RAM 1500 may store information or program codes necessary for operating the RAID storage system 1000B.

Accordingly, the RAM 1500 may store the mapping table information. The mapping table information may include address mapping table information for converting a logical address to a physical address, and stripe mapping table information indicating information for stripe grouping. The stripe mapping table information may include a ratio of valid pages in each of the stripes.

For example, the RAID controller 1100B may read the mapping table information from the NVRAM 1200 and may load the mapping table information on the RAM 1500. As another example, the RAID controller 1100B may read mapping table information from one of the plurality of storage devices (SD1 to SDn) 1300-1 to 1300-n and load the mapping table information on the RAM 1500.

The RAID controller 1100B may perform the address conversion operation during a reading operation or a writing operation in the RAID storage system 1000B by using the mapping table information loaded on the RAM 1500.

The RAID controller 1100B controls the plurality of storage devices 1300-1 to 1300-n based on a log-structured RAID environment. In particular, if the data written in the plurality of storage devices 1300-1 to 1300-n is updated, the RAID controller 1100B controls the RAID storage system 1000B to write the data in the log format at a new location, rather than overwrite the data. For example, the plurality of memory blocks in which the data is written in the log format and the memory block storing parity information for the data stored in the plurality of memory blocks form a stripe.

The RAID controller 1100B registers location information of the memory blocks in the storage devices 1300-1 to 1300-n that form the stripe to the stripe mapping table.

The RAID controller 1100B updates the mapping table information stored in the RAM 1500 due to the writing operation or the garbage collection operation and may reflect the updated mapping table information to the mapping table information stored in the NVRAM 1200. For example, the updated mapping table information may be overwritten on the NVRAM 1200.

The RAID controller 1100B may perform the address conversion process or the stripe grouping process by using the mapping table information stored in the RAM 1500. In particular, the RAID controller 1100B converts the logical address into the physical address by using the address mapping table information. In addition, the RAID controller 1100B performs the garbage collection operation in units of stripes by using the mapping table information.

The garbage collection control operations performed by the RAID controller 1100B are the same as those of the RAID controller 1100A of FIG. 1, and thus, detailed descriptions thereof will not be repeated here.

FIG. 3 is a block diagram of a RAID storage system 2000A according to another exemplary embodiment of the disclosure.

Referring to FIG. 3, the RAID storage system 2000A may include a processor 101A, a RAM 102, an NVRAM 103, a host bus adaptor (HBA) 104, an input/output (I/O) sub-system 105, a bus 106, and devices 200.

In FIG. 3, a block including the processor 101A, the RAM 102, the NVRAM 103, the HBA 104, the I/O sub-system 105, and the bus 106 becomes a host 100A, and the devices 200 may be external devices connected to the host 100A.

For example, it may be assumed that the RAID storage system 200A is a server. As another example, the RAID storage system 100A may be a personal computer (PC), a set-top box, a digital camera, a navigation device, or a mobile device. For example, the devices 200 connected to the host 100A may include storage devices (SD1 to SDn) 200-1 to 200-n.

The processor 101A may include circuits, interfaces, or program codes for performing data processing and controlling elements in the RAID storage system 2000A. For example, the processor 101A may include a central processing unit (CPU), an Acorn RISC (reduced instruction set computing) Machine architecture (ARM), or an application specific integrated circuit (ASIC).

The RAM 102 is a volatile memory, and may include SRAM or DRAM for storing data, commands, or program codes that are necessary for operating the RAID storage system 2000A. The RAM 102 stores RAID control software 102-1. The RAID control software 102-1 includes program codes for controlling the RAID storage system 2000A by the log-structured RAID method. For example, the RAID control software 102-1 may include program codes for performing a garbage collection operating method illustrated in FIGS. 30 to 33.

The NVRAM 103 is RAM, in which stored data may remain even when electric power is turned off. For example, the NVRAM 103 may include PRAM, FeRAM, or MRAM. As another example, the NVRAM 103 may include DRAM or SRAM that is volatile memory, to which electric power is supplied by using a battery or a capacitor. That is, if a system power is turned off, the DRAM or the SRAM may be driven by using the battery or the capacitor so that data stored in the DRAM or the SRAM is moved to the storage device that is the non-volatile storage space. According to the above method, the data stored in the DRAM or the SRAM may be maintained even if the system power is turned off.

A cache region for storing data that is temporarily not protected by the parity information during the garbage collection operation may be applied to the NVRAM 103.

For example, a cache region for storing data to be written in the plurality of storage devices 200-1 to 200-n in units of stripes may be allocated to the NVRAM 103.

The NVRAM 103 may store mapping table information used in the RAID storage system 2000A. The mapping table information may include address mapping table information for converting a logical address to a physical address and stripe mapping table information indicating information for stripe grouping. The stripe mapping table information may include a ratio of valid pages in each of stripes. For example, the address mapping table information may store physical addresses of the storage devices corresponding to the logical addresses.

The processor 101A controls operations of the RAID storage system 2000A in the log-structured RAID method by using the program codes stored in the RAM 102. For example, the processor 101A drives the RAID control software 102-1 stored in the RAM 102 to perform the garbage collection operating method illustrated in FIGS. 30 to 33.

The HBA 104 is an adaptor for connecting the storage devices 200-1 to 200-n to the host 100A of the RAID storage system 2000A. For example, the HBA 104 may include a small computer system interface (SCSI) adaptor, a fiber channel adaptor, and a serial advanced technology attachment (ATA) adaptor. In particular, the HBA 104 may be directly connected to the storage devices 200-1 to 200-n based on a fiber channel (FC) HBA. Also, the HBA 104 may be an interface between the host 100A and the storage devices 200-1 to 200-n by connecting in a storage area network (SAN) environment.

The I/O sub-system 105 may include circuits, interfaces, or codes operating for communicating information between components of the RAID storage system 2000A. The I/O sub-system 105 may include one or more standardized buses and one or more bus controllers. Therefore, the I/O sub-system 105 recognizes devices connected to the bus 106, lists the devices connected to the bus 106, and may perform allocation of resources and release of the resource allocation for the various devices connected to the bus 106. That is, the I/O sub-system 105 may operate to manage communications on the bus 106. For example, the I/O sub-system 105 may be a peripheral component interconnect express (PCIe) system, and may include a PCIe root complex, and one or more PCIe switches or bridges.

The storage devices 200-1 to 200-n may be SSDs or HDDs. In the present exemplary embodiment, the storage devices 200-1 to 200-n are formed as SSDs.

The processor 101A controls the storage devices 200-1 to 200-n connected via the HBA 104 based on the log-structured RAID environment. In particular, in a case of updating the data written in the storage devices 200-1 to 200-n, the processor 101A controls the RAID storage system 2000A so as to write the data as a log-type in a new location, rather than overwrite the data. For example, the plurality of memory blocks, in which the data is written in the log format, in the storage devices 200-1 to 200-n and the memory block storing parity information for the data stored in the plurality of memory blocks form a stripe.

The processor 101A registers location information of the memory blocks in the storage devices 200-1 to 200-n configuring the stripe to the stripe mapping table.

The processor 101A may perform the address conversion process or the stripe grouping process by using the mapping table information stored in the NVRAM 103. In particular, the processor 101A converts the logical address into the physical address by using the address mapping table information. In addition, the processor 101A performs the garbage collection operation in units of stripes by using the stripe mapping table information.

The processor 101A selects a victim stripe for performing the garbage collection by using the mapping table information. For example, the processor 101A determines a stripe having the lowest ratio of the valid pages from among the stripes that are grouped by using the stripe mapping table information and selects the stripe as the victim stripe.

The processor 101A performs a control operation to copy valid pages of the plurality of storage devices 200-1 to 200-n included in the victim stripe for performing the garbage collection to the NVRAM 103 and performs a garbage collection control operation by using the data copied to the NVRAM 103. In particular, the processor 101A performs a control operation for copying the valid pages in the plurality of storage devices 200-1 to 200-n, included in the victim stripe for performing the garbage collection, to the orphan cache region of the NVRAM 103.

The processor 101A performs a control operation for erasing the memory blocks including the parity information included in the victim stripe of the storage devices 200-1 to 200-n, a control operation for copying the valid pages included in the victim stripe to the memory block that is to form a new stripe, and a control operation for erasing the memory block of the victim stripe, which stores the valid pages copied to the memory block that is to form the new stripe.

The processor 101A calculates parity information for the data copied to the orphan cache region in the NVRAM 103 and copies the calculated parity information to the memory block that is to form the new stripe of the storage devices 200-1 to 200-n.

The processor 101A registers stripe grouping information for configuration of the new stripe to the stripe mapping table, with respect to the memory blocks to which the valid pages included in the victim stripe are copied, and the memory block to which the parity information is copied. In addition, the processor 101A deletes the stripe grouping information for the victim stripe from the stripe mapping table. Accordingly, the memory blocks included in the victim stripe become free blocks.

After deleting the memory block storing the parity information included in the victim stripe during the garbage collection operation of the RAID storage system 2000A, the valid pages written in the memory blocks included in the victim stripe of the storage devices 200-1 to 200-n may not be protected by using the parity information. That is, if there is a defect in some of the plurality of storage devices 200-1 to 200-n, the valid pages written in the memory block of the defective storage device in the victim stripe may not restore the data damaged by the defect using the parity information.

According to an exemplary embodiment of the disclosure, since the valid pages of the plurality of storage devices 200-1 to 200-n included in the victim stripe are stored in the orphan cache region of the NVRAM 103, even if some of the plurality of storage devices 200-1 to 200-n have failures, the valid pages written in the memory blocks of the storage devices having the failures may be restored by using the data stored in the orphan cache region of the NVRAM 103.

When a request to read the pages included in the victim stripe occurs during the garbage collection operation, the processor 101A reads data for the pages that are requested to be read from the orphan cache region of the NVRAM 103.

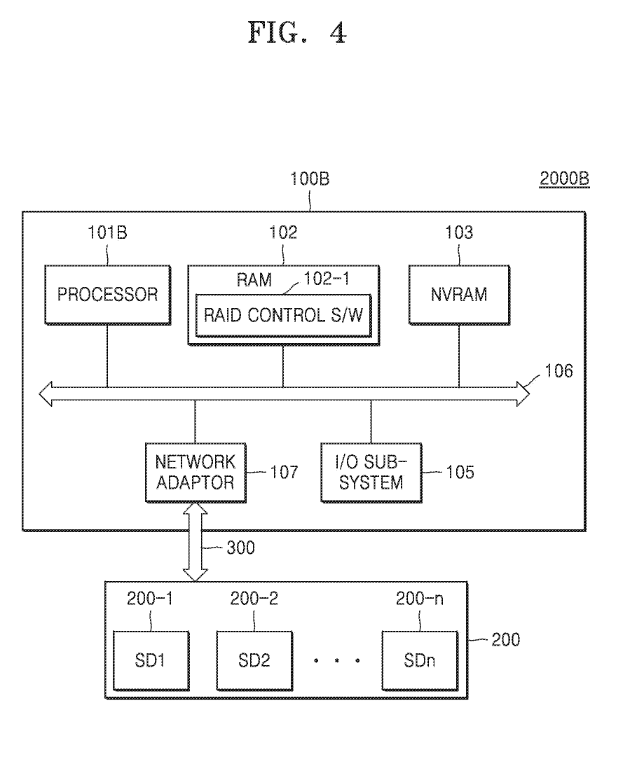

FIG. 4 is a block diagram of a modified example of the RAID storage system according to an exemplary embodiment of the disclosure.

Referring to FIG. 4, the RAID storage system 2000B includes a host 100B, network devices 200, and a link unit 300.

The host 100B may include a processor 101B, a RAM 102, the NVRAM 103, a network adaptor 107, the I/O sub-system 105, and the bus 106. For example, the host 100B may be assumed to be a server. As another example, the host 100B may be a PC, a set-top box, a digital camera, a navigation device, or a mobile device.

The RAM 102, the NVRAM 103, the I/O sub-system 105, and the bus 106 forming the host 100B are the same as those of the RAID storage system 2000A shown in FIG. 3, and thus, detailed descriptions thereof will not be repeated.

The network adaptor 107 may be coupled to the devices 200 via the link unit 300. For example, the link unit 300 may include copper wirings, fiber optic cables, one or more wireless channels, or combinations thereof.

The network adaptor 107 may include circuits, interfaces, or codes capable of operating to transmit and receive data according to one or more networking standards. For example, the network adaptor 107 may communicate with the devices 200 according to one or more Ethernet standards.

The devices 200 may include the storage devices SD1 to SDn 200-1 to 200-n. For example, the storage devices 200-1 to 200-n may be formed as SSDs or HDDs. In the present exemplary embodiment, the storage devices 200-1 to 200-n are formed as the SSDs.

The processor 101B controls the storage devices 200-1 to 200-n connected via the network adaptor 107 based on the log-structured RAID environment. In particular, in a case of updating the data written in the storage devices 200-1 to 200-n, the processor 101B controls the RAID storage system 2000B so as to write the data as a log-type in a new location, rather than overwrite the data. For example, the plurality of memory blocks, in which the data is written in the log format, in the storage devices 200-1 to 200-n and the memory block storing parity information for the data stored in the plurality of memory blocks form a stripe.

The processor 101B registers location information of the memory blocks in the storage devices 200-1 to 200-n configuring the stripe to the stripe mapping table.

The processor 101B may perform the address conversion process or the stripe grouping process by using the mapping table information stored in the NVRAM 103. In particular, the processor 101B converts the logical address into the physical address by using the address mapping table information. In addition, the processor 101B performs the garbage collection operation in units of stripes by using the stripe mapping table information.

The garbage collection operation performed by the processor 101B is performed in substantially the same manner as the processor 101A of FIG. 3, and thus, detailed descriptions thereof will not be repeated.

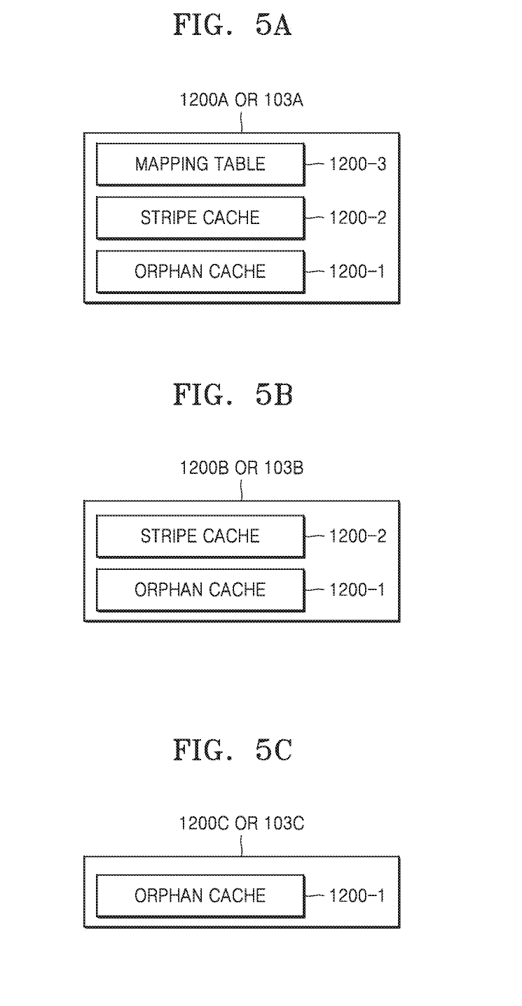

FIGS. 5A to 5C are diagrams showing various examples of setting storage regions in the NVRAM 1200 or 103 shown in FIGS. 1 to 4.

Referring to FIG. 5A, an orphan cache region 1200-1, a stripe cache region 1200-2, and a mapping table storage region 1200-3 are allocated to an NVRAM 1200A or 103A according to the present exemplary embodiment.

The orphan cache region 1200-1 stores orphan data that is temporarily not protected by the parity information during the garbage collection operation. The stripe cache region 1200-2 stores data to be written in the storage devices in units of stripes. The mapping table storage region 1200-3 stores mapping table information for converting logical addresses into physical addresses and stripe mapping table information indicating information for stripe grouping. The stripe mapping table information may include information of a valid page ratio in each of the grouped stripes. For example, the address mapping table information may store physical addresses of the storage devices corresponding to the logical addresses.

Referring to FIG. 5B, the orphan cache region 1200-1 and the stripe cache region 1200-2 are allocated to the NVRAM 1200B or 103B according to another exemplary embodiment. In the present exemplary embodiment, the mapping table storage region 1200-3 may be allocated to the RAM 1500 or 102.

Referring to FIG. 5C, the orphan cache region 1200-1 is allocated to an NVRAM 1200C or 103C according to another exemplary embodiment. The stripe cache region 1200-2 and the mapping table storage region 1200-3 may be allocated to the RAM 1500 or 102.

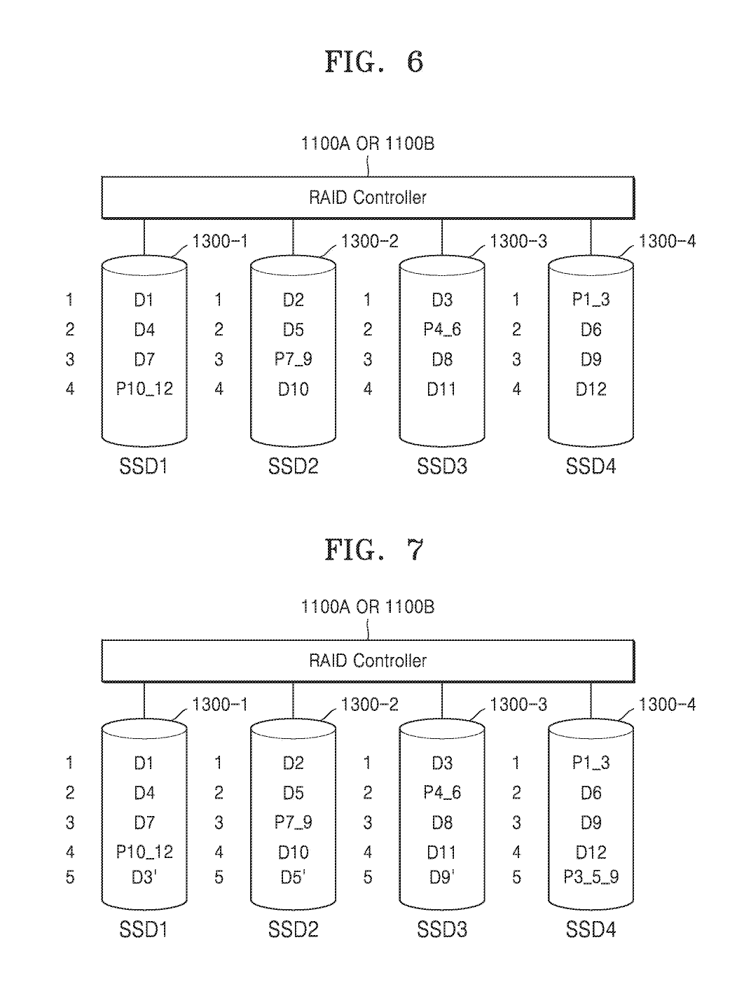

FIG. 6 is a conceptual view illustrating a writing operation according to a parity-based RAID method in the RAID storage system according to an exemplary embodiment of the disclosure.

For convenience of description, FIGS. 6 to 13 show the RAID controller 1100A or 1100B and the storage devices (for example, four SSDs, that is, first to fourth SSDs 1300-1 to 1300-4) that are elements of the RAID storage system 1000A or 1000B shown in FIG. 1 or 2.

In the RAID storage system 2000A or 2000B shown in FIG. 3 or FIG. 4, the processor 101A or 101B performs operations of the RAID controller 1100A or 1100B. Also, the four SSDs may be denoted by reference numerals 200-1 to 200-4.

FIG. 6 shows an example, in which parity-based RAID is applied to the first to fourth SSDs 1300-1 to 1300-4. Parity information with respect to data stored at the same addresses in the first to fourth SSDs 1300-1 to 1300-4 is stored in one of the first to fourth SSDs 1300-1 to 1300-4. For example, the parity information may be a result value from an XOR calculation with respect to the value of data at the same addresses in the first to fourth SSDs 1300-1 to 1300-4. Even if one piece of the data is lost, the lost data may be restored by using the parity information and the other pieces of data. According to the above principle, even if one of the SSDs is damaged, the data in the SSD may be restored.

Referring to FIG. 6, the data is sequentially stored in the first to fourth SSDs 1300-1 to 1300-4. For example, parity information P1_3 for data D1 to data D3 is stored in the fourth SSD 1300-4. In addition, parity information P4_6 for data D4 to data D6 is stored in the third SSD 1300-3, parity information P7_9 for data D7 to data D9 is stored in the second SSD 1300-2, and parity information P10_12 for data D10 to data D12 is stored in the first SSD 1300-1.

It is assumed that the second SSD 1300-2 is defective. Here, first data D2 of the second SSD 1300-2 may be restored by using a value obtained by performing an XOR calculation on data D1, D3, and the parity information P1_3, second data D5 of the second SSD 1300-2 may be restored by using a value obtained by performing an XOR calculation on data D4, D6, and the parity information P4_6, and fourth data D10 may be restored by using a value obtained by performing an XOR calculation on data D11, D12, and the parity information P10_12.

In such a parity-based RAID method as described above, one small write updating operation causes two reading operations and two writing operations, thereby degrading a performance of entire I/O operations and accelerating abrasion of the SSDs.

In FIG. 6, it is assumed that data D3 stored in the third SSD 1300-3 is updated. Here, the parity information P1_3 for the data D3 has to be updated so as to ensure reliability of the corresponding data. Therefore, in order to write the data D3, existing data D3 is read and the existing parity information P1_3 is read, and then, the data D3 and the parity information are XOR calculated with new data D3′ to generate new parity information P1_3′. Then, the new data D3′ is written and the new parity information P1_3′ is written. As described above, a problem that one writing operation is amplified to two reading operations and two writing operations is referred to as a read-modify-write phenomenon.

According to one or more exemplary embodiments of the disclosure, the read-modify-write phenomenon may be addressed by using the log-structured RAID method. This will be described below with reference to FIG. 7.

FIG. 7 is a conceptual view illustrating a log-structured RAID method in the RAID storage system according to an exemplary embodiment of the disclosure.

First, it is assumed that data D3 is updated to data D3′ in a state where data is stored in the first to fourth SSDs 1300-1 to 1300-4 in the RAID storage system. Here, the data D3′ is not updated on a first address of the third SSD 1300-3, in which the data D3 is already written, but is written in a fifth address of the first SSD 1300-1. Also, new data D5′ and D9′ may be written in new locations in the log format without being overwritten. When writing operations of data D3′, D5′, and D9′ configuring one stripe are finished, parity information P3_5_9 for the data configuring the same stripe is written in the fourth SSD 1300-4.

When the updating operation according to the log-structured RAID method is finished, the first to fourth SSDs 1300-1 to 1300-4 store the updated data and updated parity information as shown in FIG. 7.

A case where each of the first to fourth SSDs 1300-1 to 1300-4 performs the garbage collection operation independently will be described below.

For example, it will be assumed that the data D3, which becomes invalid when the data D3′ is written, is deleted from the third SSD 1300-3 through the garbage collection operation, and then, the second SSD 1300-2 is defective. Then, in order to restore the data D2 stored in the second SSD 1300-2, the data D1 stored in the first SSD 1300-1, the data D3 stored in the third SSD 1300-3, and the parity information P1_3 of the fourth SSD 1300-4 are necessary. However, since the data D3 is deleted from the third SSD 1300-3 through the garbage collection operation, restoration of the data D2 becomes impossible.

In order to address the above problem, the garbage collection operation is performed in units of stripes according to exemplary embodiments of the disclosure. For example, data D1, D2, and D3, and the parity information P1_3 configuring one stripe are processed through one garbage collection operation.

If the log-structured RAID method is applied, a RAID controller uses a logical address-logical address mapping table, and an SSD layer uses a logical address-physical address mapping table to perform the address conversion process. For example, in the logical address-logical address mapping table in the RAID layer, numbers of the storage device and the memory block corresponding to a logical block address are stored, and in the logical address-physical address mapping table in the SSD layer, a physical address of a flash memory corresponding to the logical block address may be stored.

As described above, when two mapping tables are used, a size of the mapping table increases, the garbage collection operations are performed separately in the RAID layer and the SSD layer, and thus, a write amplification factor (WAF) may increase. The garbage collection operation in the RAID layer is necessary for newly ensuring a logical empty space for a new writing operation, and the garbage collection operation in the SSD layer is necessary for newly ensuring a physical empty space by performing an erasing operation from the memory block of a flash memory chip for the new writing operation.

According to an exemplary embodiment of the disclosure, the logical address-logical address mapping table in the RAID layer and the logical address-physical address mapping table in the SSD layer are combined as one and managed by the RAID controller 1100A or 1100B or the processor 101A or 101B of the host.

The combined address mapping table may store mapping information for directly converting the logical address into the physical address. For example, the address mapping table information may include a physical address of the storage device corresponding to a logical address. In particular, the address mapping table information may include numbers of the storage devices corresponding to the logical addresses and physical addresses of the storage devices.

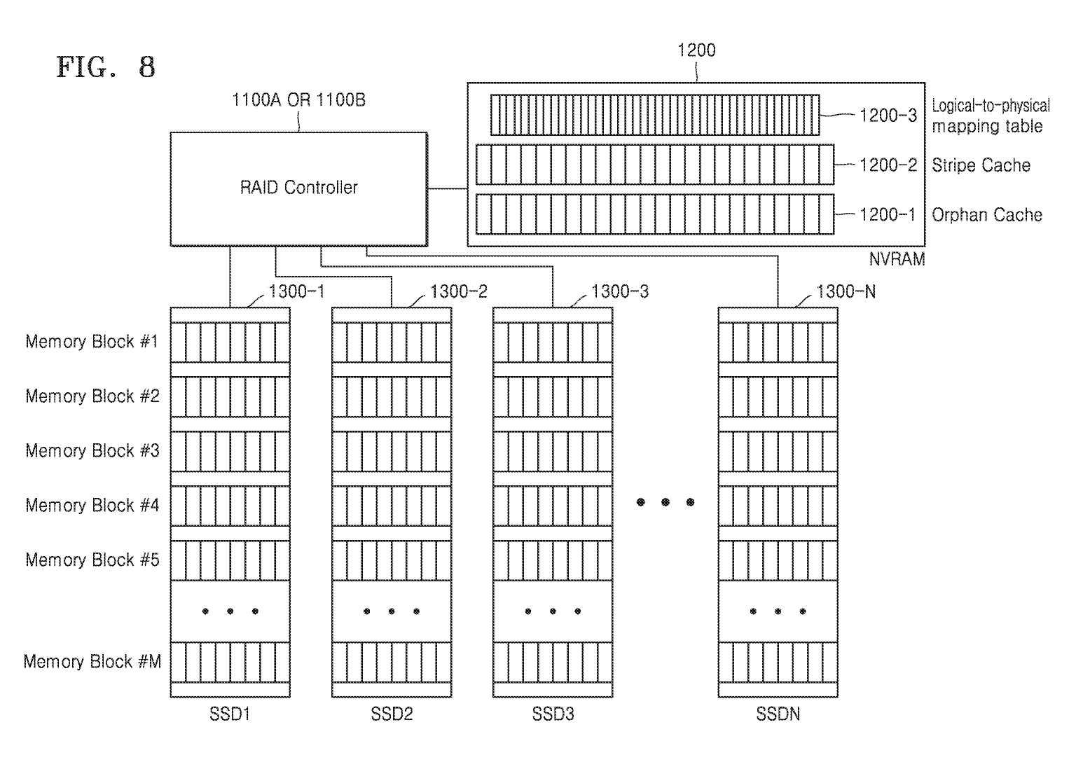

FIG. 8 is a diagram illustrating an example of executing an SSD-based log-structured RAID method in the RAID storage system by using an NVRAM, according to an exemplary embodiment of the disclosure.

For example, an SSD1 to an SSDN 1300-1 to 1300-N each include a plurality (M) of memory blocks. In an SSD, the reading or writing operation may be performed in units of pages, but the erasing operation is performed in units of memory blocks. A memory block may be also referred to as an erase block. In addition, each of the M memory blocks may include a plurality of pages.

In FIG. 8, one memory block includes eight pages, but is not limited thereto. That is, one memory block may include less than or greater than eight pages.

In addition, the orphan cache region 1200-1, the stripe cache region 1200-2, and the mapping table storage region 1200-3 are allocated to the NVRAM 1200.

The RAID controller 1100A or 1100B converts the logical address into the physical address by using the address mapping table information stored in the mapping table storage region 1200-3.

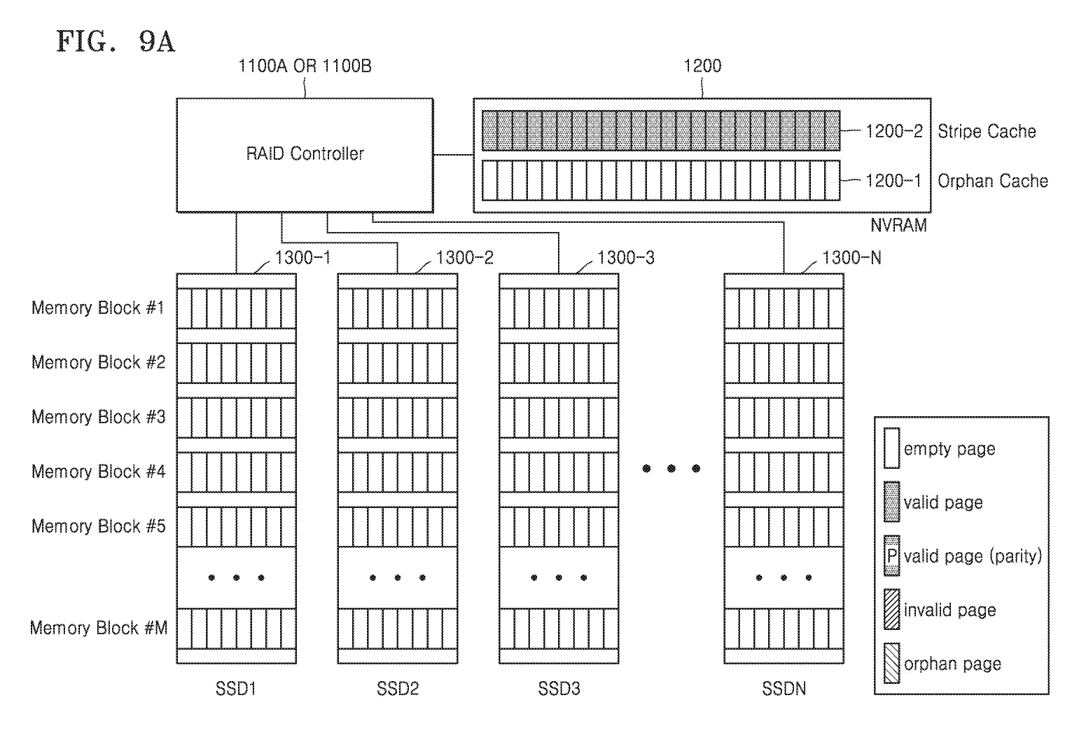

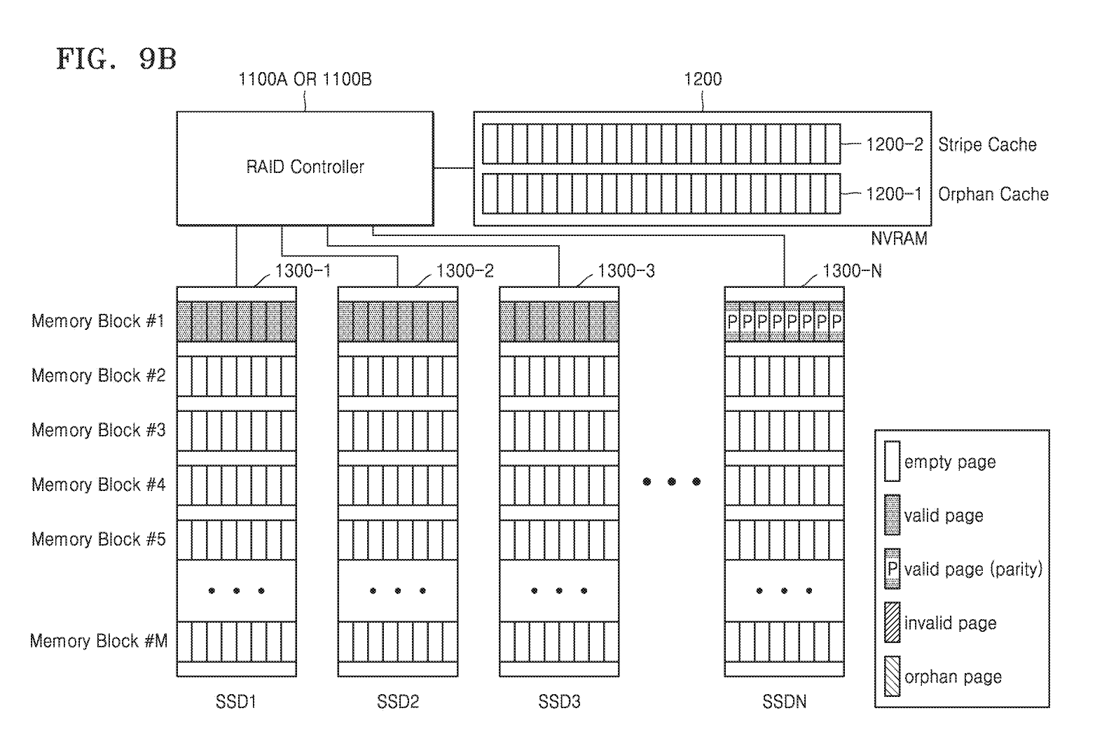

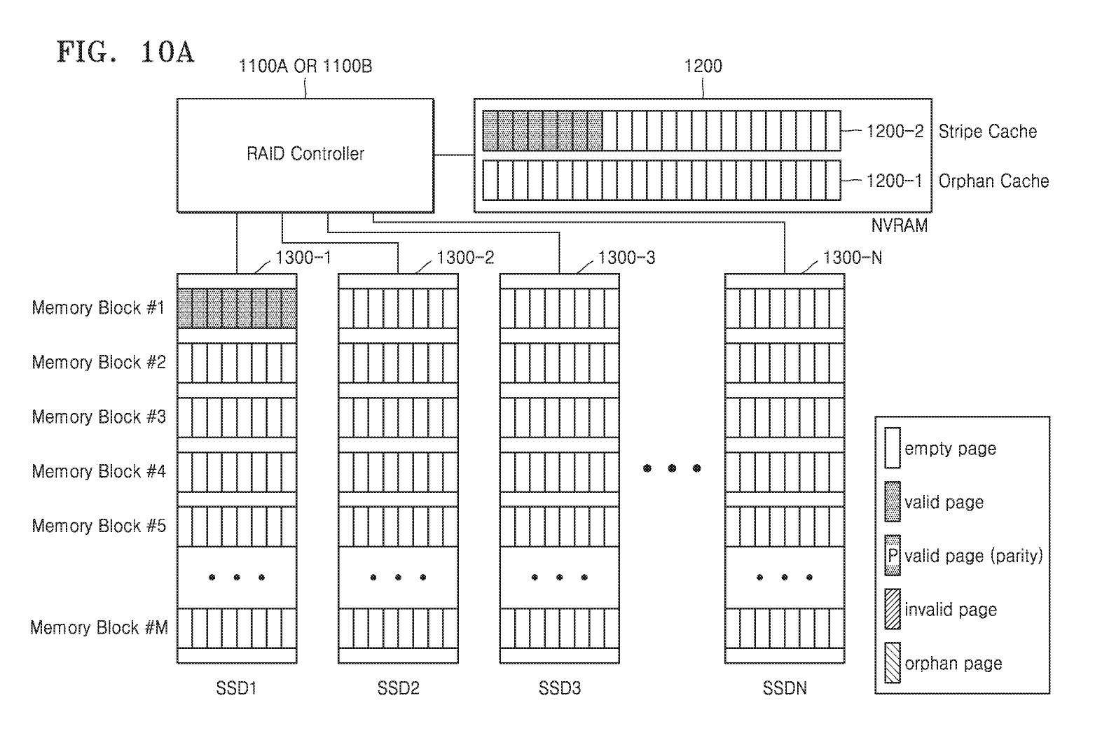

An example of performing the writing operation by using the NVRAM according to the SSD-based log-structured RAID method in the RAID storage system of FIG. 8 will be described below with reference to FIGS. 9A and 9B.

FIGS. 9A and 9B are conceptual diagrams illustrating the writing operation performed in units of stripes in the RAID storage system according to an exemplary embodiment of the disclosure.

When a write request occurs in the RAID storage system 1000A or 1000B, the RAID controller 1100A or 1100B stores data to be written in the stripe cache region 1200-2 of the NVRAM 1200. The data to be written is firstly stored in the stripe cache region 1200-2 in order to write data of one full stripe, including parity information, in the SSD1 to SSDN 1300-1 to 1300-N at once. FIG. 9A shows an example of storing the data to be written in units of stripes in the stripe cache region 1200-2 of the NVRAM 1200.

Next, the RAID controller 1100A or 1100B calculates the parity information for the data stored in the stripe cache region 1200-2. After that, the RAID controller 1100A or 1100B performs a control operation for writing one full stripe data including the calculated parity information and the data stored in the stripe cache region 1200-2 in the SSD1 to SSDN 1300-1 to 1300-N. In FIG. 9B, memory blocks #1 in the SSD1 to SSD(N−1) 1300-1 to 1300-(N−1) store the data in the stripe cache regions 1200-2 thereof, and the SSDN 1300-N stores the parity information. In FIG. 9B, each memory block #1 included in each of the SSD1 to SSDN 1300-1 to 1300-N may be registered as a new stripe.

As described above, in the present exemplary embodiment illustrated in FIGS. 9A and 9B, data in one full stripe is written at once. According to the above method, the parity information corresponding to the memory block size may be calculated at once, and thus, fragmented writing and parity calculations may be prevented. However, a stripe cache region corresponding to one full stripe has to be ensured, and excessively large number of writing I/Os and parity calculation overhead may be generated at once.

According to another exemplary embodiment of the disclosure, the data may be written in the SSD1 to SSDN 1300-1 to 1300-N by the memory block unit. In addition, according to another exemplary embodiment of the disclosure, the data may be written in the SSD1 to SSDN 1300-1 to 1300-N in units of pages.

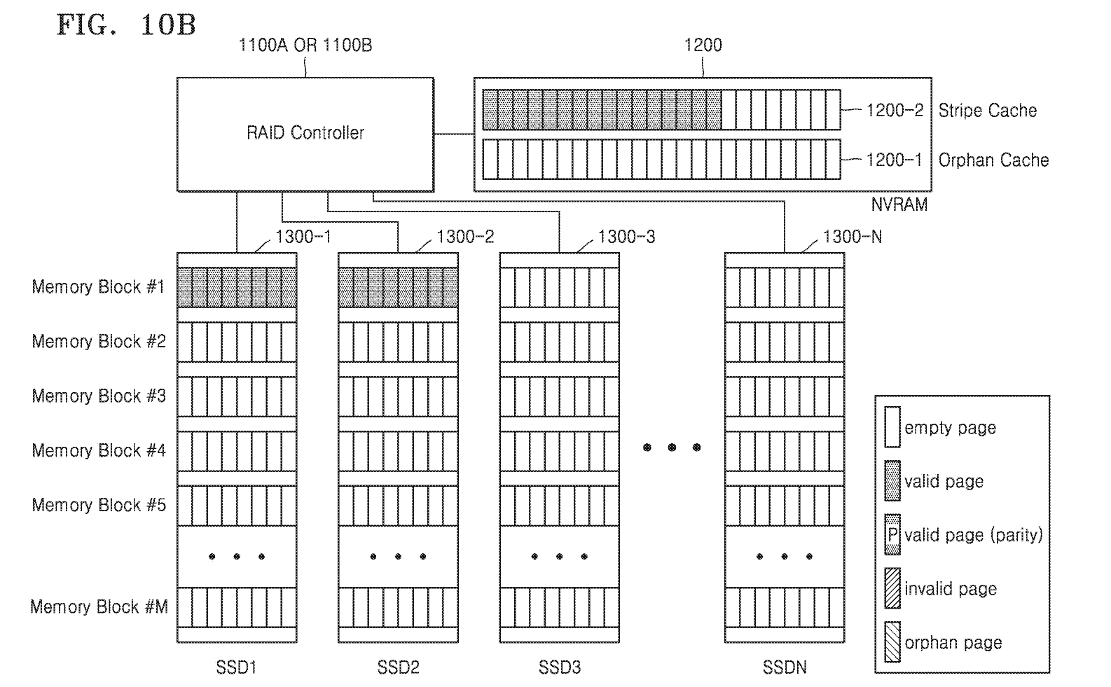

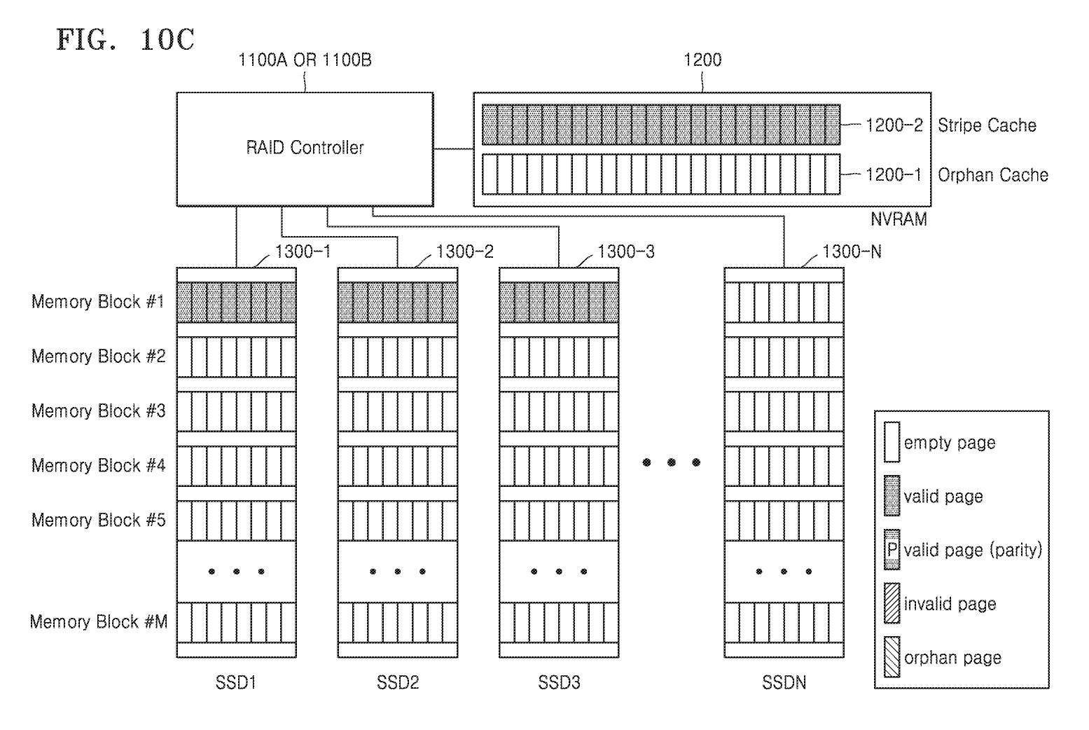

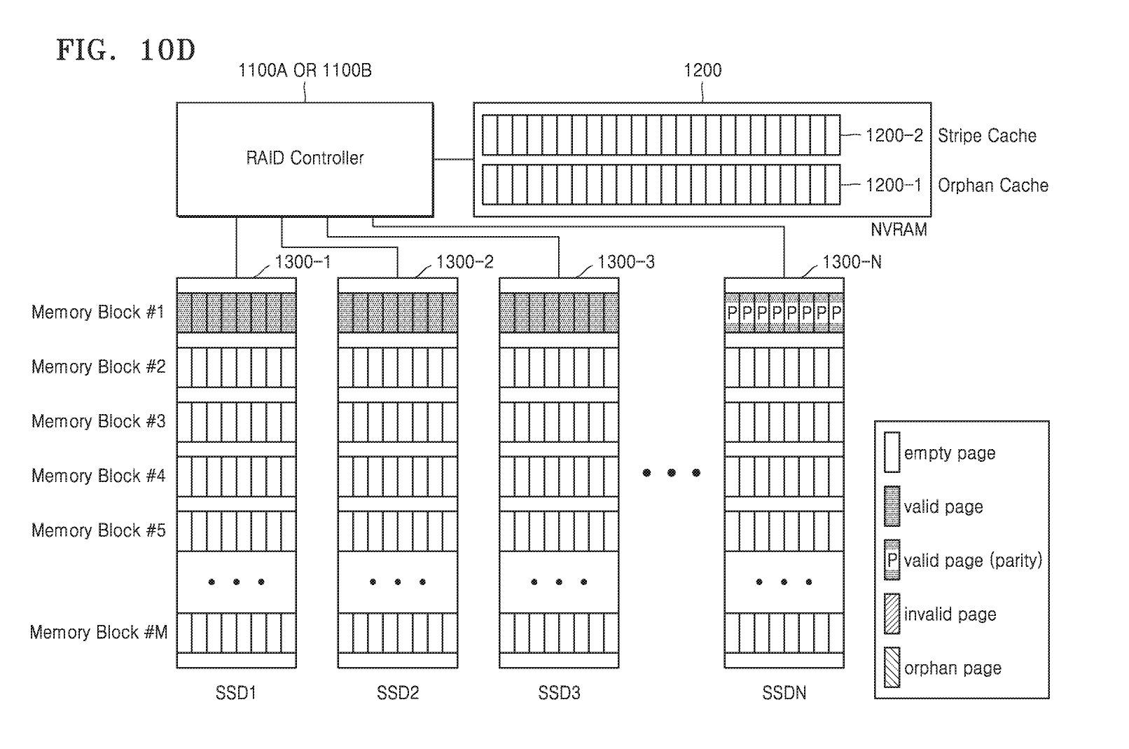

FIGS. 10A to 10D are conceptual diagrams illustrating processes of storing data by writing the data in the storage devices in the memory block unit in the RAID storage system according to an exemplary embodiment of the disclosure.

The RAID controller 1100A or 1100B sequentially stores the data to be written in the NVRAM 1200. When the data equivalent in size to one memory block is initially collected in the NVRAM 1200, the RAID controller 1100A or 1100B reads the data from the NVRAM 1200, and writes the read data in the memory block #1 that is empty in the SSD1 1300-1. Accordingly, as shown in FIG. 10A, the data is stored in the NVRAM 1200 and the SSD1 to SSDN 1300-1 to 1300-N.

Next, when the data equivalent in size to one memory block is secondarily collected in the NVRAM 1200, the RAID controller 1100A or 1100B reads the data corresponding to a size of the second memory block from the NVRAM 1200, and writes the read data in the memory block #1 that is empty in the SSD2 1300-2. Accordingly, as shown in FIG. 10B, the data is stored in the NVRAM 1200 and in the SSD1 to SSDN 1300-1 to 1300-N.

Then, when the data corresponding to one memory block is collected in the NVRAM 1200, the RAID controller 1100A or 1100B reads the data corresponding to a size of the third memory block and writes the read data in the memory block #1 that is empty in the SSD3 1300-3. Accordingly, the data is stored in the NVRAM 1200 and the SSD1 to SSDN 1300-1 to 1300-N as shown in FIG. 10C.

After writing the data sequentially in the SSD1 to SSD(N−1) configuring one stripe as described above, the RAID controller 1100A or 1100B calculates parity information with respect to entire data configuring one stripe and stored in the NVRAM 1200, and writes the calculated parity information in the memory block #1 that is empty in the SSDN 1300-N. After that, the RAID controller 1100A or 1100B performs a flushing operation for emptying the NVRAM 1200. Accordingly, the data is stored in the NVRAM 1200 and in the SSD1 to SSDN 1300-1 to 1300-N as shown in FIG. 10D.

As described above, the method of writing the data in units of memory blocks may perform the writing operation of the data in each SSD in units of memory blocks. However, a stripe cache region corresponding to one full stripe has to be ensured, and excessively large number of writing I/Os and parity calculation overhead may be generated at once.

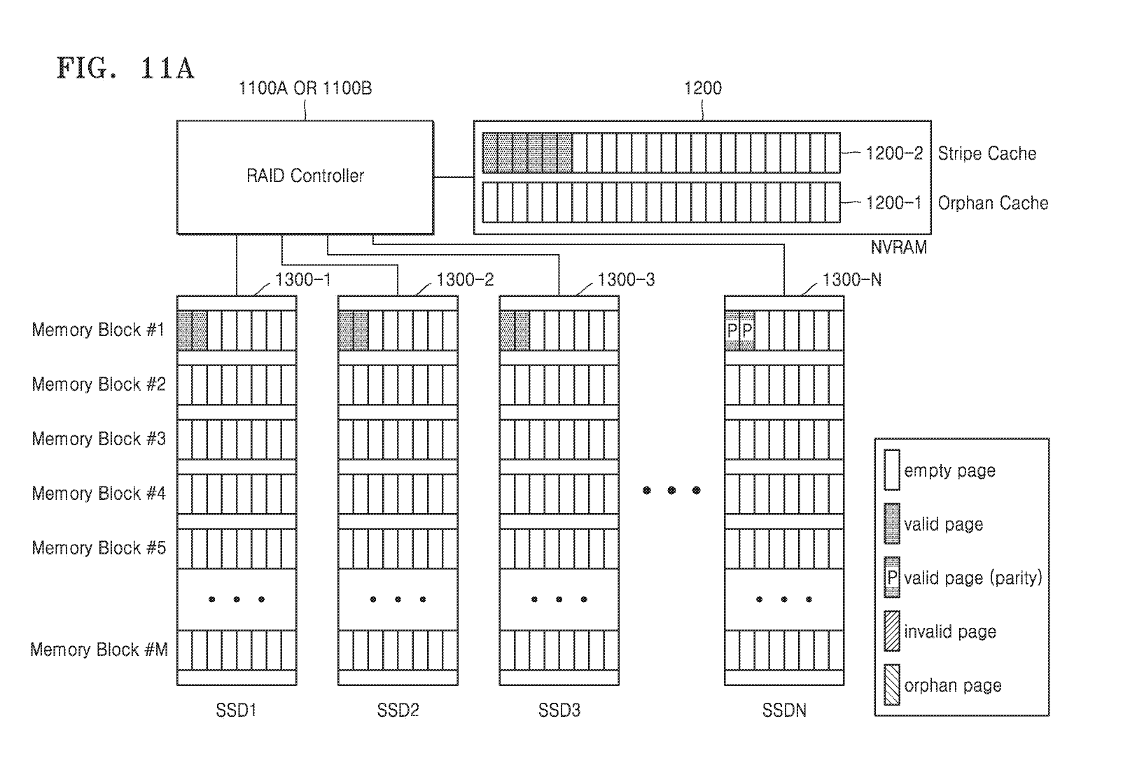

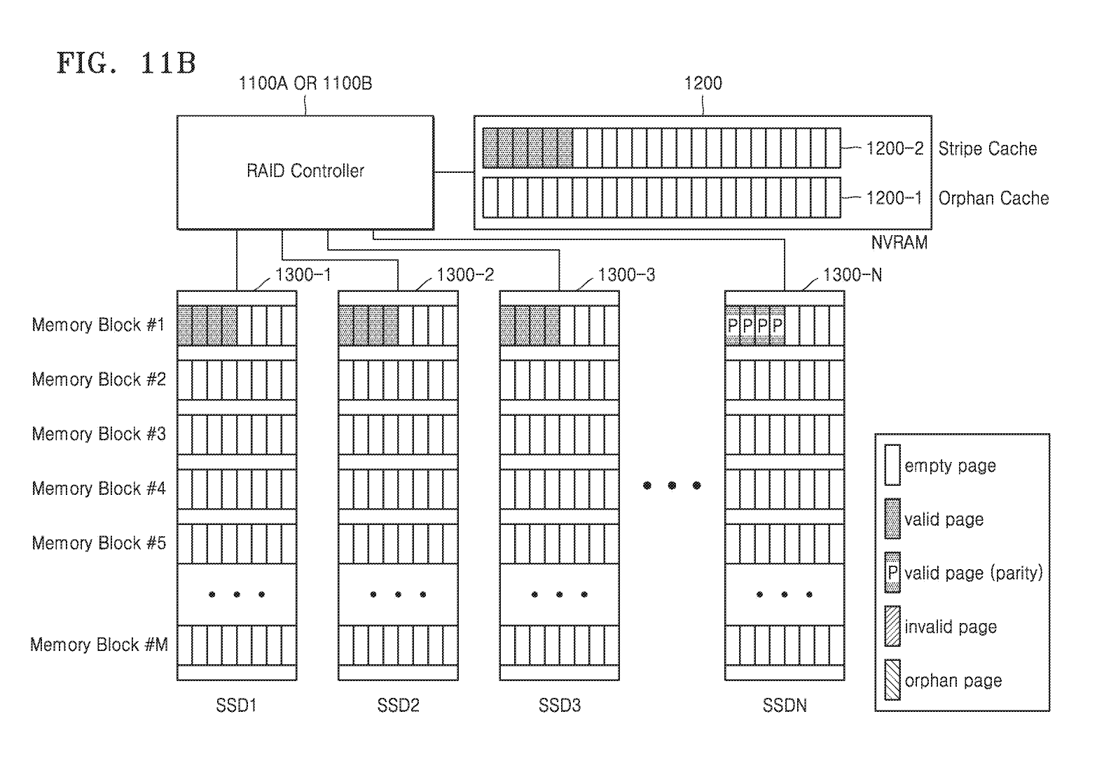

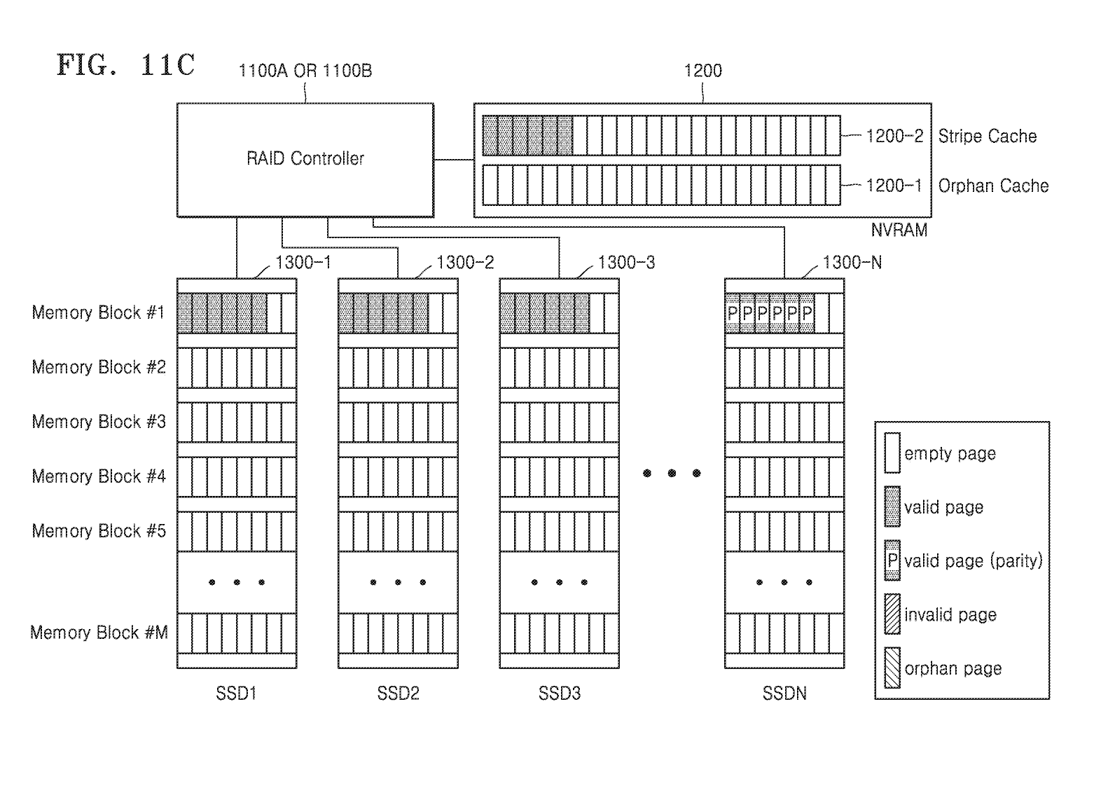

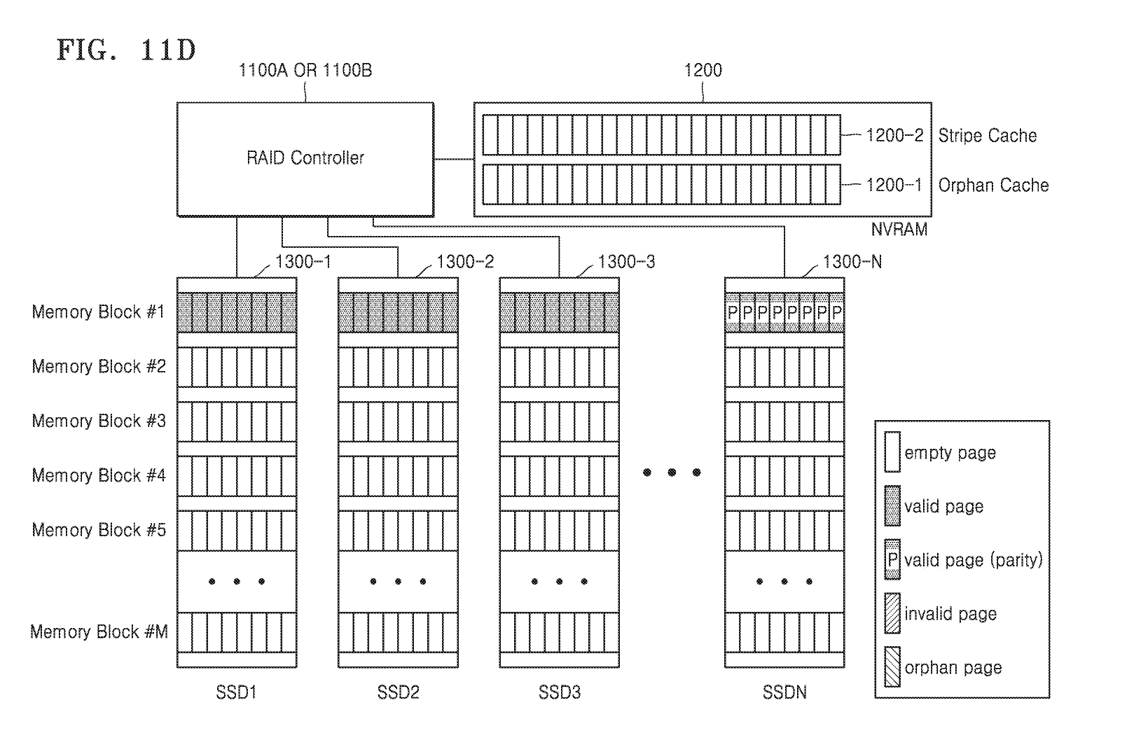

FIGS. 11A to 11D are conceptual diagram illustrating processes of storing data in the storage devices in units of pages, in the RAID storage system according to an exemplary embodiment of the disclosure.

The RAID controller 1100A or 1100B sequentially stores data to be written in the NVRAM 1200. When the data is collected in the NVRAM 1200 sufficient enough to calculate parity information, the RAID controller 1100A or 1100B reads the data from the NVRAM 1200, and writes the read data in the memory blocks #1 of the SSD1 to SSDN 1300-1 to 1300-N in units of pages. For example, the size of data that is sufficient enough to calculate the parity information may be (N−1) pages, that is, 1 subtracted from N that is the number of SSDs configuring one stripe.

Then, the RAID controller 1100A or 1100B calculates the parity information for the data stored in the NVRAM 1200, and writes the calculated parity information in a first page of the memory block #1 that is empty in the SSDN 1300-N. After writing the data and the parity information in the SSD1 to SSDN 1300-1 to 1300-N, the RAID controller 1100A or 1100B may flush the data from the NVRAM 1200.

As another example, when the data that is K times (where K is an integer equal to or greater than 2) greater than a size, by which the parity may be calculated, is collected in the NVRAM 1200, the RAID controller 1100A or 1100B reads the data from the NVRAM 1200 and writes the read data in the memory blocks #1 of the SSD1 to SSDN 1300-1 to 1300-N in units of pages. For example, if a value of K is 2, the data of two pages may be written in the memory block in each of the SSDs configuring the stripe.

FIGS. 11A to 11D show that the data of two pages and the parity information are sequentially stored in the memory blocks #1 in the SSD1 to SSDN configuring the stripe.

As described above, the method of writing data in the page unit may distribute a load of the parity calculation in units of pages, and the load of parity calculation that has to be performed at once may be reduced. In addition, there is no need to ensure the stripe cache region corresponding to one full stripe. However, the writing operation may not be performed in each of the SSDs in units of memory blocks.

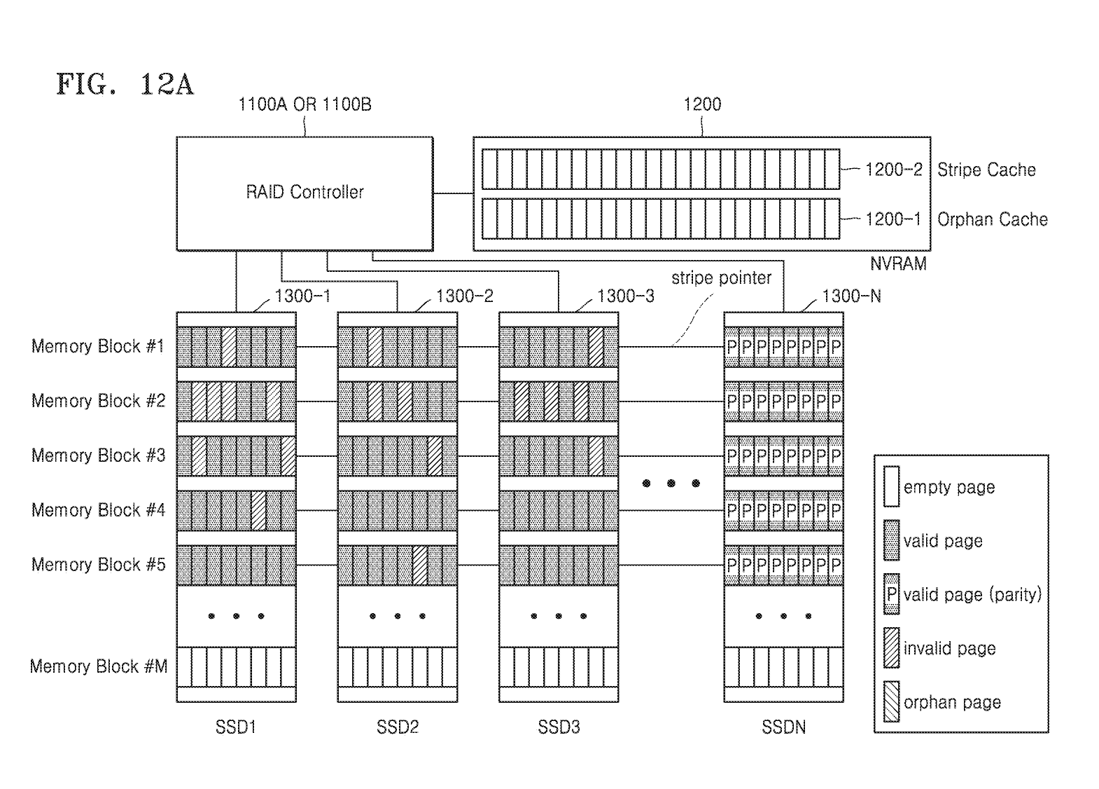

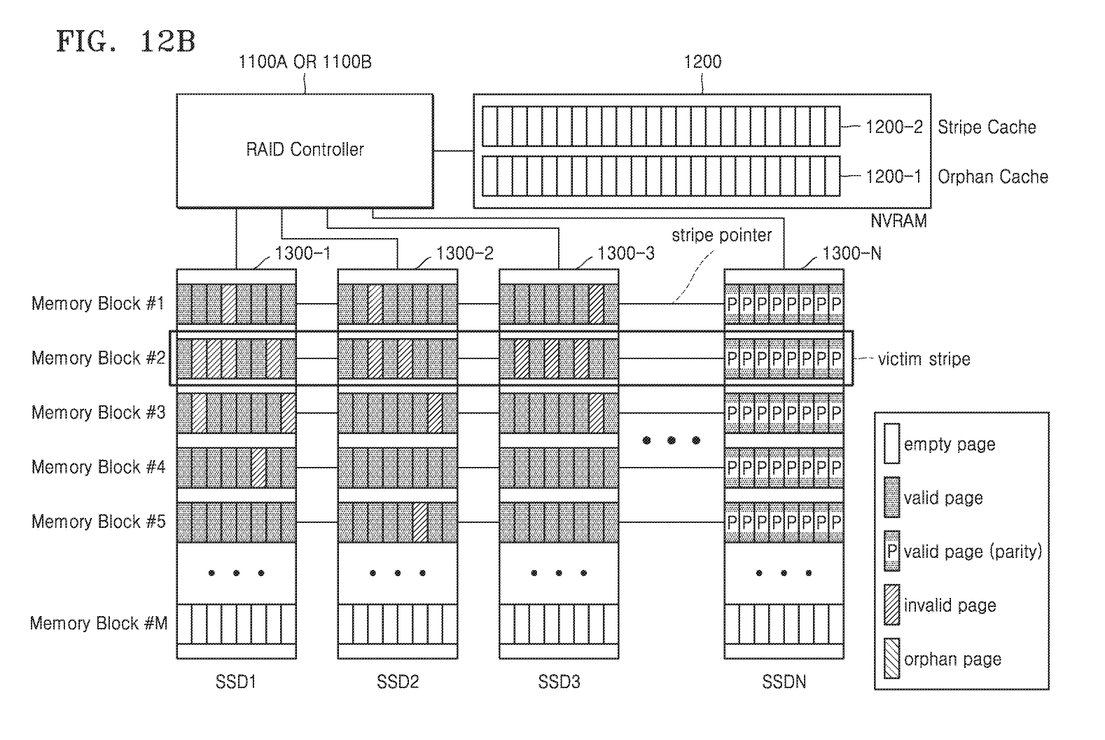

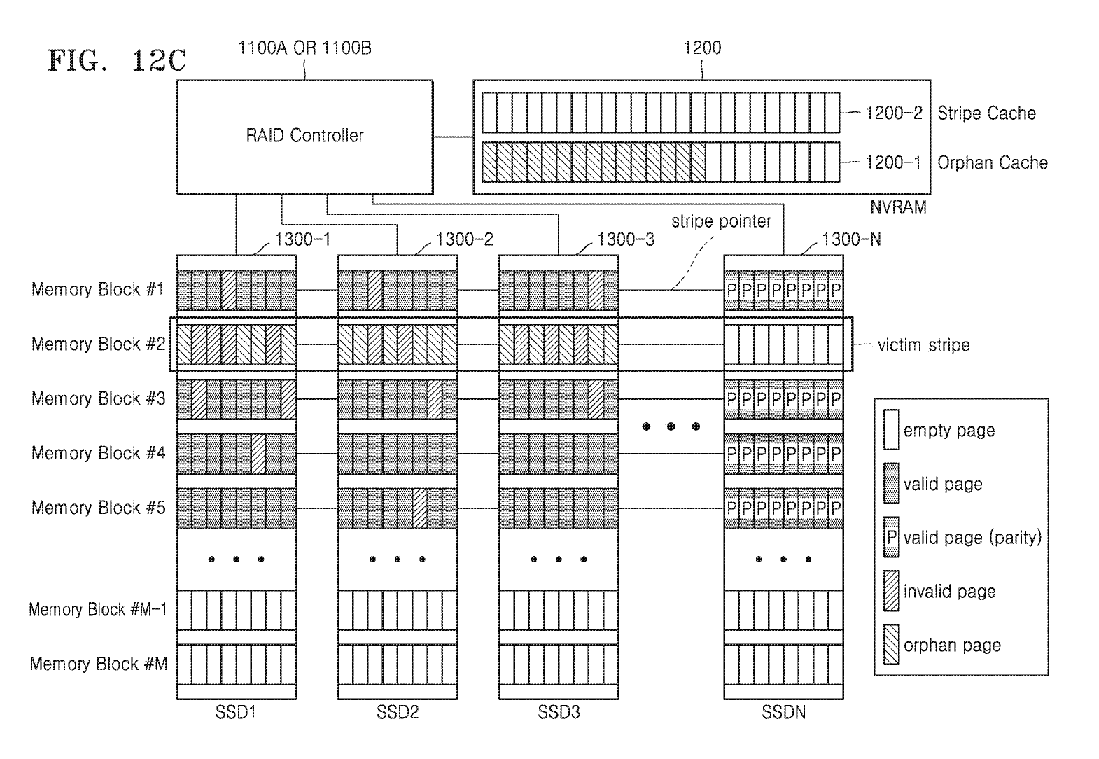

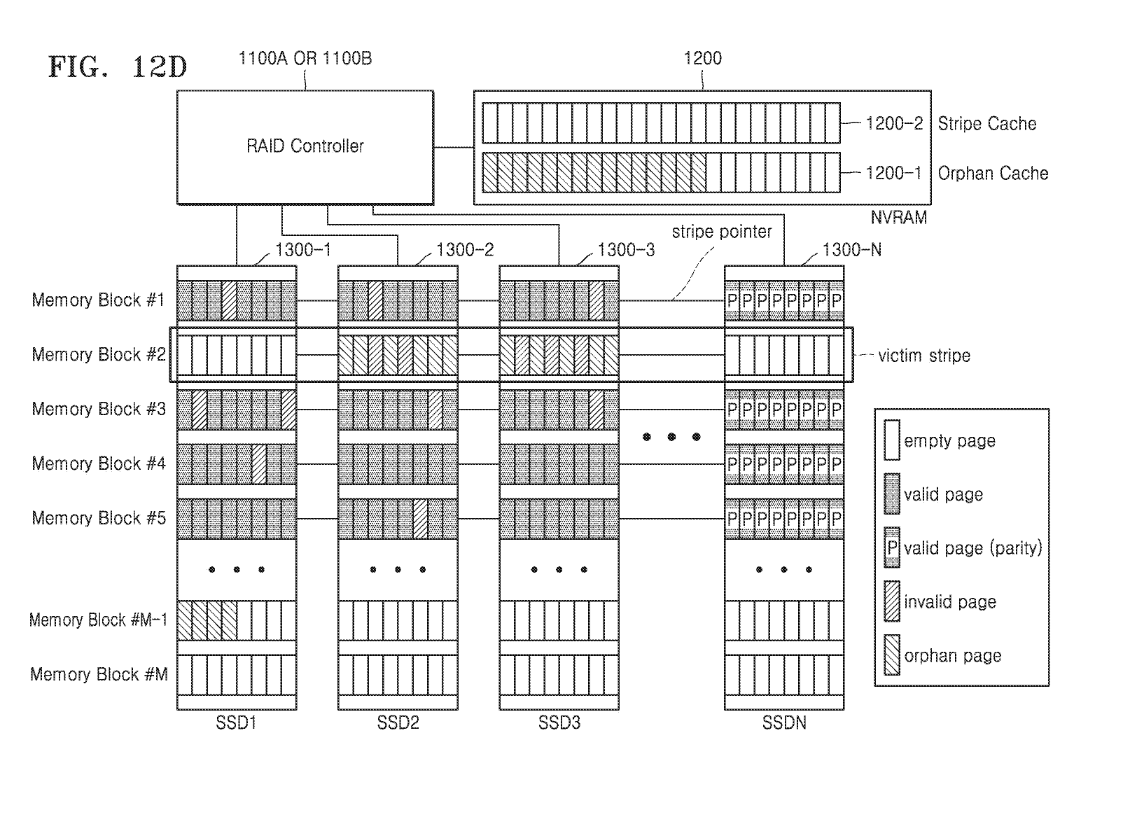

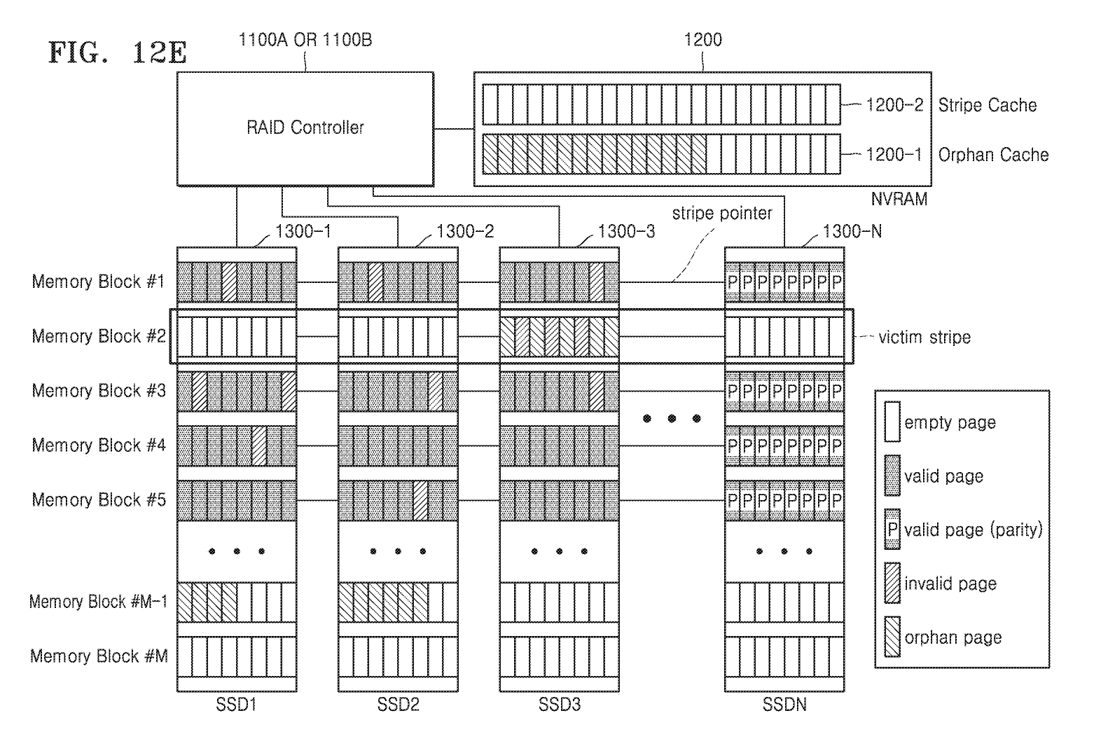

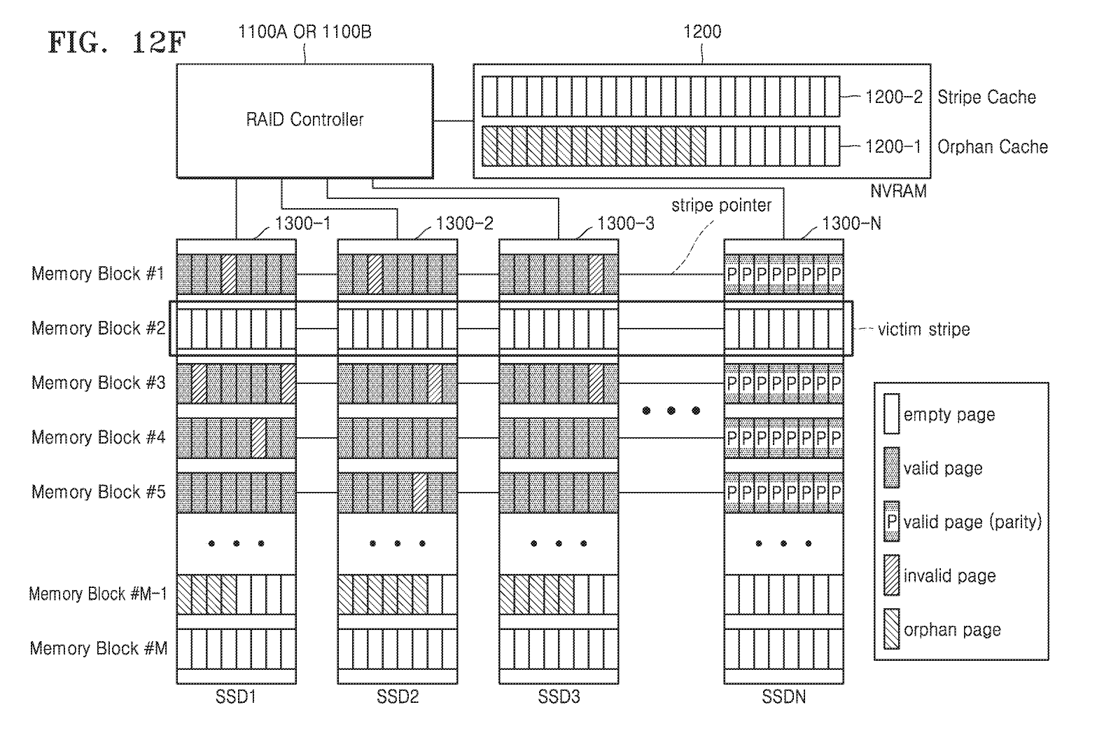

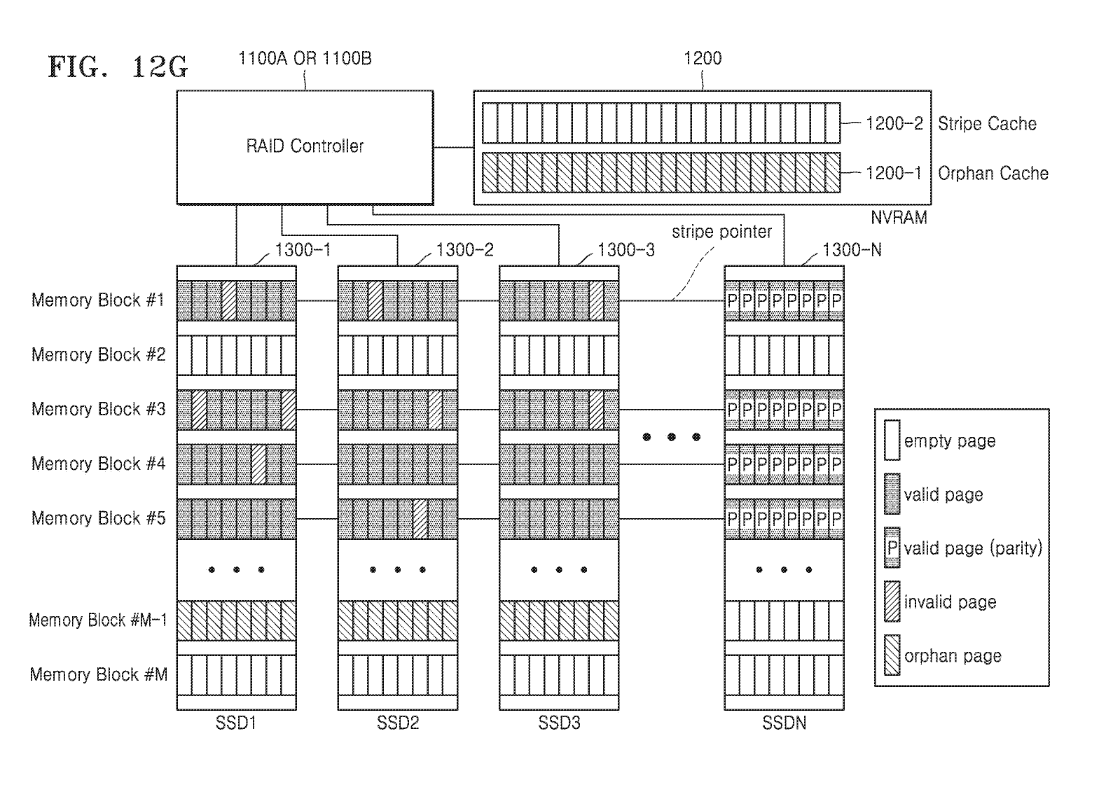

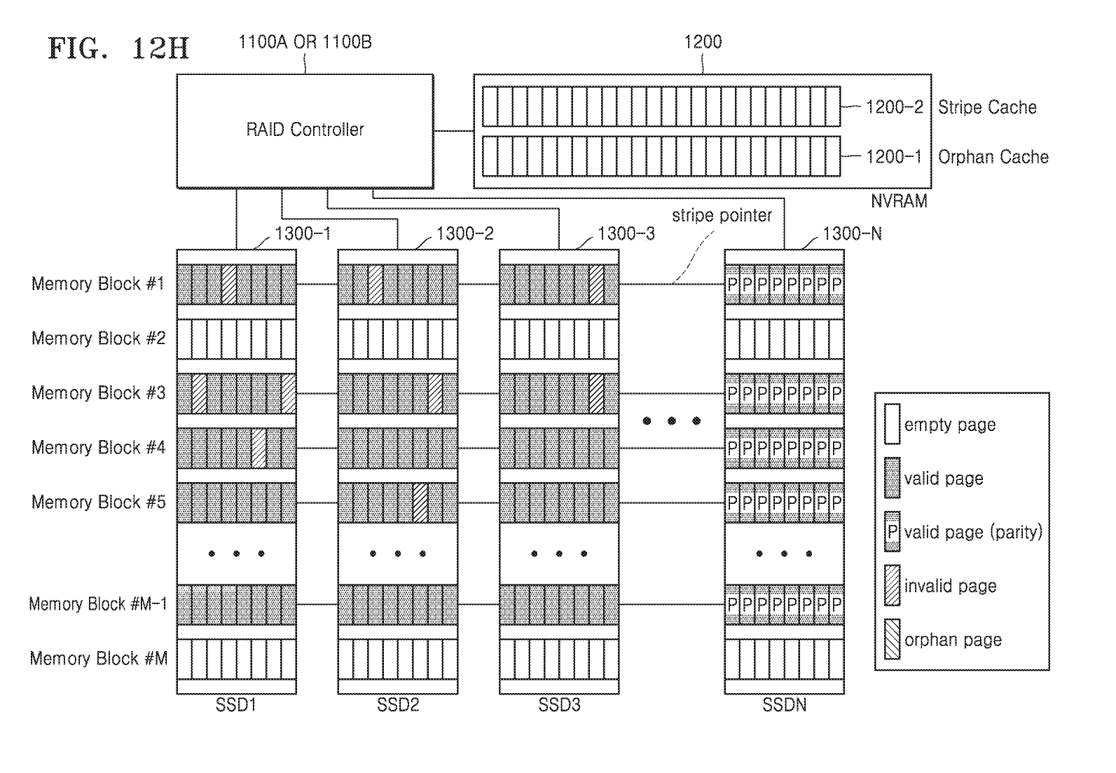

FIGS. 12A to 12H are conceptual diagrams illustrating processes of performing the garbage collection operation in the RAID storage system according to an exemplary embodiment of the disclosure.

In FIG. 12A, an example of storing data in the SSD1 to SSDN 1300-1 to 1300-N according to the writing operation performed in the RAID storage system is shown.

In the RAID storage system, a new writing operation is performed with respect to the same logical address, the data existing in the logical address becomes invalid data, and a page in which the invalid data is stored is represented as an invalid page. In addition, the memory blocks in the SSDs configuring one stripe are connected to one another by a stripe pointer. Accordingly, the stripe including the memory block in each SSD may be recognized by using the stripe pointer. The stripe pointer may be generated by the stripe mapping table information that is described above.

When the writing operation is performed in the RAID storage system, a garbage collection operation is necessary for ensuring a new storage space. In the RAID storage system according to an exemplary embodiment of the disclosure, the garbage collection operation is performed in units of stripes.

When a request for the garbage collection is generated in the RAID storage system, the RAID controller 1100A or 1100B selects a victim stripe that is a target of the garbage collection. For example, a stripe having the highest ratio of invalid pages to total pages may be selected as a victim stripe. In other words, a stripe having the lowest ratio of valid pages may be selected as the victim stripe.

If the request for the garbage collection occurs in a state where the data is stored in the SSD1 to SSDN 1300-1 to 1300-N as shown in FIG. 12A in the RAID storage system, a stripe, at a second place from the top, having the highest ratio of invalid pages is selected as the victim stripe as shown in FIG. 12B.

After selecting the victim stripe as shown in FIG. 12B, the RAID controller 1100A or 1100B copies the valid pages included in the victim stripe to the orphan cache region 1200-1 of the NVRAM 1200. After finishing the copying process, the RAID controller 1100A or 1100B deletes the parity information included in the victim stripe. Data storage states in the SSD1 to SSDN 1300-1 and 1300-N and in the NVRAM 1200, after the above operations are performed, are as shown in FIG. 12C. Accordingly, the orphan cache region 1200-1 stores data of the pages that is temporarily not protected by the parity information. The valid page that is temporarily not protected by the parity information may be referred to as an orphan page, and the data stored in the orphan page may be referred to as orphan data.

Referring to FIG. 12C, although the parity information included in the victim stripe is deleted, the data of all the valid pages included in the victim stripe is stored in the orphan cache region 1200-1, and thus, reliability of the data in the victim stripe may be ensured.

If a request for reading the valid pages included in the victim stripe occurs during the garbage collection process, the RAID controller 1100A or 1100B directly reads the orphan pages that are requested to be read from the orphan cache region 1200-1 of the NVRAM 1200. That is, the RAID controller 1100A or 1100B directly reads the orphan page from the orphan cache region 1200-1 of the NVRAM 1200, without reading the pages from the SSD1 to SSDN 1300-1 to 1300-N. As such, with respect to the request for reading the valid pages in the victim stripe during the garbage collection operation, the data reading may be performed with a low latency by using the NVRAM 1200.

Next, the RAID controller 1100A or 1100B copies the valid pages included in the victim stripe to the memory block that will form a new stripe. For example, the valid pages of the victim stripe may be copied to another memory block for configuring a new stripe, in the same SSD in which the valid pages of the victim stripe are stored. As another example, the valid pages included in the victim stripe may be evenly distributed and copied to the memory blocks that are to form a new stripe.

For example, the memory block that will form the new stripe may be allocated as a storage region for copying the valid pages included in the victim stripe for the garbage collection. That is, the RAID controller 1100A or 1100B manages the memory blocks so as not to store the data of a normal writing operation in the memory block for configuring the new stripe, which is allocated to copy the valid pages during the garbage collection operation.

For example, an operation of copying the valid pages to the memory block for configuring the new stripe in the same SSD, in which the valid pages of the victim stripe are stored, will be described below.

The RAID controller 1100A or 1100B copies orphan pages located in the memory block #2 of the SSD1 1300-1 to a memory block # M−1 in the SSD1 1300-1. After that, the RAID controller 1100A or 1100B deletes the data in the memory block #2 of the SSD1 1300-1. The data storage states in the SSD1 to SSDN 1300-1 to 1300-N and in the NVRAM 1200, after the above operations are performed, are as shown in FIG. 12D.

In the same manner, the RAID controller 1100A or 1100B copies the orphan pages located in the memory block #2 of the SSD2 1300-1 to a memory block # M−1 of the SSD 1300-2. After that, the RAID controller 1100A or 1100B deletes the data from the memory block #2 of the SSD2 1300-2. The data storage states in the SSD1 to SSDN 1300-1 to 1300-N and in the NVRAM 1200, after the above operations are performed, are as shown in FIG. 12E.

Also, the RAID controller 1100A or 1100B copies the orphan pages located in the memory block #2 of the SSD3 1300-3 to a memory block # M−1 of the SSD3 1300-3. After that, the RAID controller 1100A or 1100B deletes the data from the memory block #2 of the SSD3 1300-3. The data storage states in the SSD1 to SSDN 1300-1 to 1300-N and in the NVRAM 1200, after the above operations are performed, are as shown in FIG. 12F.

According to an exemplary embodiment, the RAID controller 1100A or 1100B manages the memory block, to which the orphan pages are copied, to store only the orphan pages obtained according to the garbage collection operation. The orphan data is remaining data while the invalid data that is initially stored with the orphan data is deleted through the garbage collection. That is, since the orphan data is proven to have a long data lifetime, it is not effective that the orphan data be stored with the data of the normal writing operation in one memory block. Storing data having similar data lifetimes in one memory block is effective to minimize an internal valid page copy during the garbage collection.

If an additional garbage collection is performed on one or more other victim stripes (not shown), as exemplified by FIGS. 12A through 12F, the data storage states of SSD1˜SSDN and NVRAM may be shown as FIG. 12G. That is, FIG. 12G shows that the memory block # M−1 of each of SSD1˜SSDN is filled with orphan pages after an additional garbage collection is performed on one or more other victim stripes (not shown). Thus, when the garbage collection is performed in the above manner on multiple stripes, each of the memory blocks # M−1 in the SSD1 to SSD(N−1) 1300-1 to 1300-(N−1) is filled with the orphan data. The data storage states in this case in the SSD1 to SSDN 1300-1 to 1300-N and in the NVRAM 1200 are as shown in FIG. 12G.

Then, the RAID controller 1100A or 1100B calculates the parity information for the orphan data stored in the NVRAM 1200, and writes the calculated parity information in the memory block # M−1 of the SSDN 1300-N. After writing the parity information, the orphan data stored in the memory blocks # M−1 of the SSD1 to SSD(N−1) 1300-1 to 1300(N−1) is converted into valid pages that may be protected by the parity information stored in the memory block # M−1 of the SSDN 1300-N. In addition, the RAID controller 1100A or 1100B generates a new stripe consisting of the memory blocks # M−1 in the SSD1 to SSDN 1300-1 to 1300-N, and registers location information of the memory blocks configuring the new stripe to the stripe mapping table. After writing the parity information, the RAID controller 1100A or 1100B flushes the orphan data stored in the orphan cache region 1200-1 of the NVRAM 1200. The data storage states in the SSD1 to SSDN 1300-1 to 1300-N and in the NVRAM 1200, after the above operations are performed, are as shown in FIG. 12H.

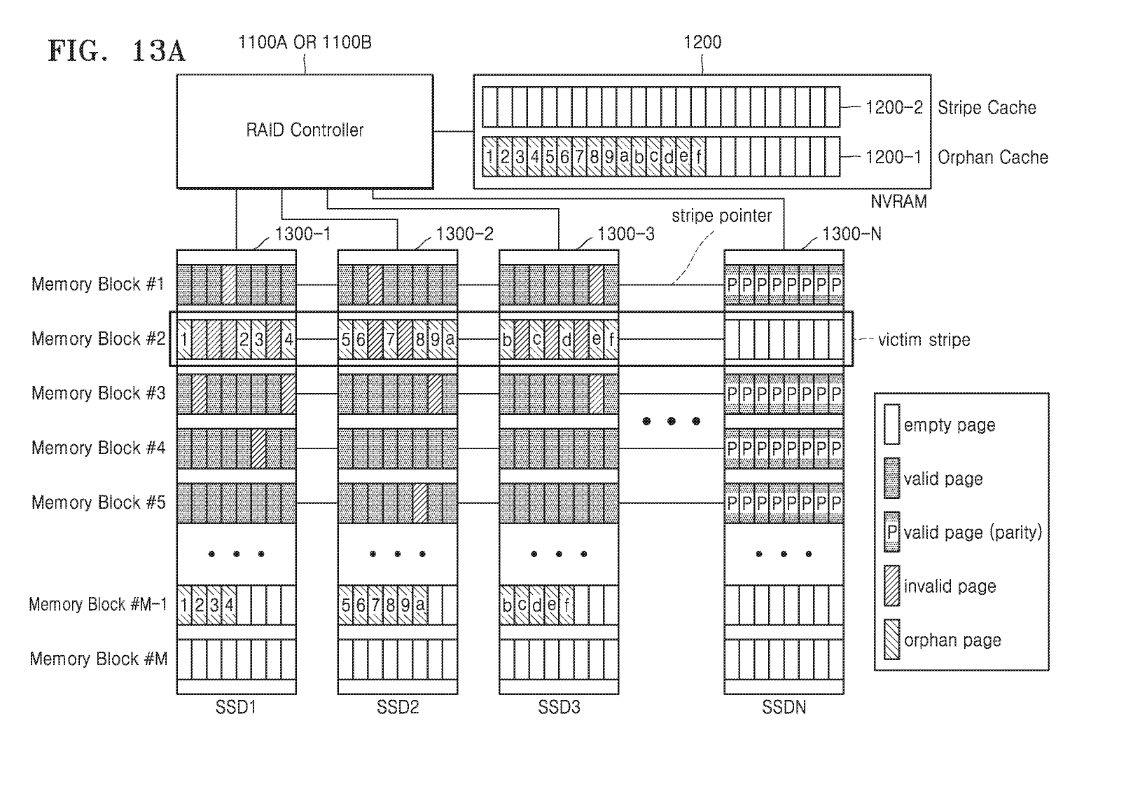

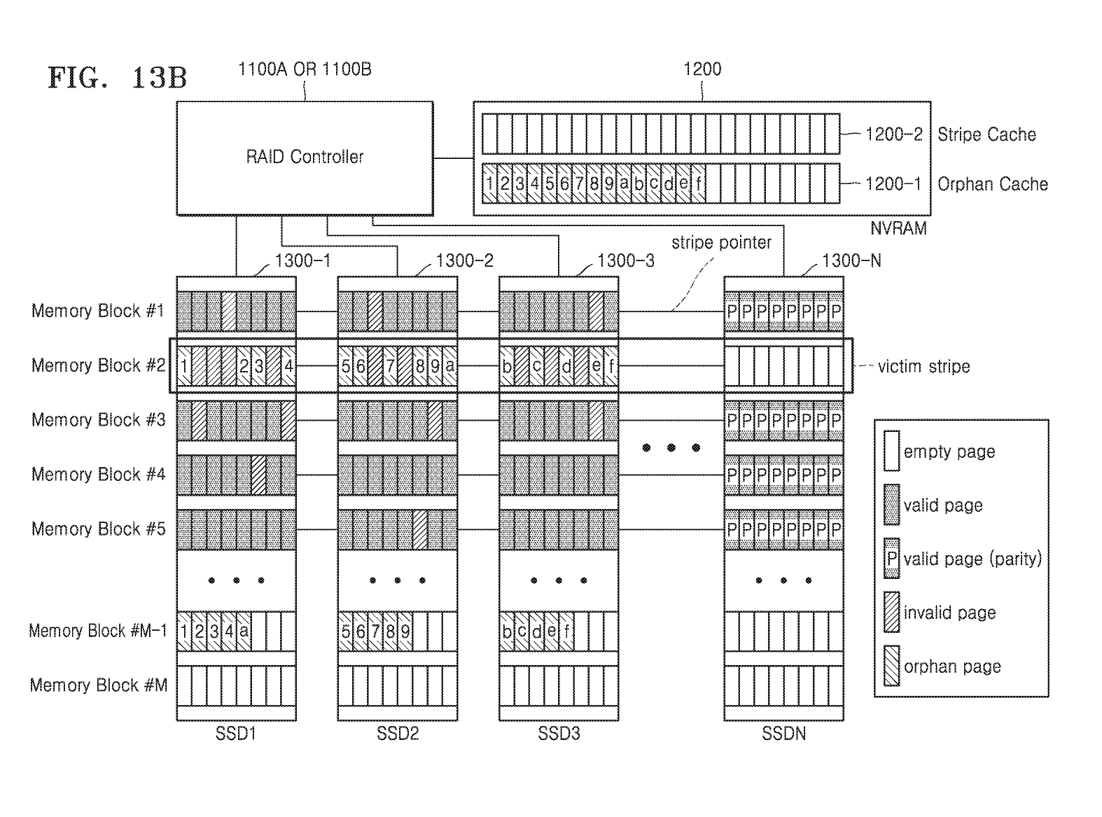

FIGS. 13A and 13B are conceptual diagrams illustrating examples of copying valid pages included in the victim stripe to a memory block to form a new stripe, during the garbage collection operation in the RAID storage system according to an exemplary embodiment of the disclosure.

Referring to FIGS. 13A and 13B, since the parity information for the valid pages included in the victim stripe is deleted, the valid pages included in the victim stripe become orphan pages.

Referring to FIG. 13A, the orphan pages included in the victim stripe are only copied within the same SSD. That is, the orphan pages 1, 2, 3, and 4 included in the memory block #2 of the SSD 1300-1 are copied to the memory block # M−1 of the SSD1 1300-1, and orphan pages 5, 6, 7, 8, 9, and a included in the memory block #2 of the SSD2 1300-2 are copied to the memory block # M−1 in the SSD2 1300-2, and orphan pages b, c, d, e, and f included in the memory block #2 of the SSD3 1300-3 are copied to the memory block # M−1 of the SSD3 1300-3.

According to the above method of copying the orphan pages within the same SSD, the copying operation of the orphan pages is only executed in the SSD. Accordingly, I/O may be performed only via an internal I/O bus in the SSD, and an external I/O does not need to operate, and accordingly, I/O bus traffic may be reduced. However, the numbers of orphan pages in the memory blocks of the victim stripe may be different from each other, and thus, the number of times the erasing operations are performed may increase.

As another example, the orphan pages may be freely copied without regard to the SSD in which the orphan pages are originally stored.

According to this method, an operation of copying the orphan pages from the orphan cache region 1200-1 to pages of the flash memories configuring the SSDs is performed. Accordingly, the number of orphan pages in each of the SSDs is the same as those in other SSDs, and thus, it is easy to generate the parity information from the orphan pages and convert the orphan pages into the normal valid pages. Also, the number of times the erasing operations are performed may be reduced. However, since the operation of copying the orphan pages is performed by using the external I/O bus, the I/O bus traffic increases and copying latency may increase.

As another example, some orphan pages are copied within the same SSD and other of the orphan pages are copied from the NVRAM 1200 to another SSD in order to obtain a balance between all the orphan pages.

In particular, the balance between the orphan pages may be obtained through the following processes.

First, an average value of the valid pages is calculated by dividing the total number of the valid pages in the victim stripe by the number of memory blocks except for the memory block storing the parity information.

Next, the valid pages included in each of the memory blocks configuring the victim stripe are copied to the memory block for configuring a new stripe within the same SSD in the range of less than or equal to the average value.

Next, the other valid pages included in the victim stripe are copied to the memory blocks for configuring the new stripe so that the valid pages may be evenly stored in the memory blocks in the SSDs for configuring the new stripe.

The above operations will be described below with reference to FIG. 13B.

For example, the total number of the valid pages included in the memory blocks #2 of the SSD1 to SSD3 1300-1 to 1300-3 is 15. Therefore, the average value of the valid pages per an SSD in the victim stripe becomes 5. Thus, 5 or less valid pages included in each of the memory blocks configuring the victim stripe are copied to a new memory block within the same SSD.

The memory block #2 of the SSD1 1300-1 has four orphan pages 1, 2, 3, and 4. Accordingly, the orphan pages 1, 2, 3, and 4 in the memory block #2 of the SSD1 1300-1 are copied to the memory block # M−1 of the SSD1 1300-1.

Next, the memory block #2 of the SSD2 1300-2 has six orphan pages 5, 6, 7, 8, 9, and a. Accordingly, only five orphan pages from among the orphan pages 5, 6, 7, 8, 9, and a of the memory block #2 are copied to another memory block of SSD2 1300-2. For example, five orphan pages 5, 6, 7, 8, and 9 except for one orphan page a, from among the orphan pages 5, 6, 7, 8, 9, and a of the memory block #2 in the SSD2 1300-2, are copied to the memory block # M−1 of the SSD2 1300-2.

Next, the memory block #2 of the SSD3 1300-3 has five orphan pages b, c, d, e, and f Therefore, the orphan pages b, c, d, e, and f located in the memory block #2 of the SSD31300-3 are copied to the memory block # M−1 of the SSD3 1300-3.

In addition, the orphan page a stored in the orphan cache region 1200-1 of the NVRAM 1200 is copied to the memory block # M−1 of the SSD1 1300-1 through an external copying operation.

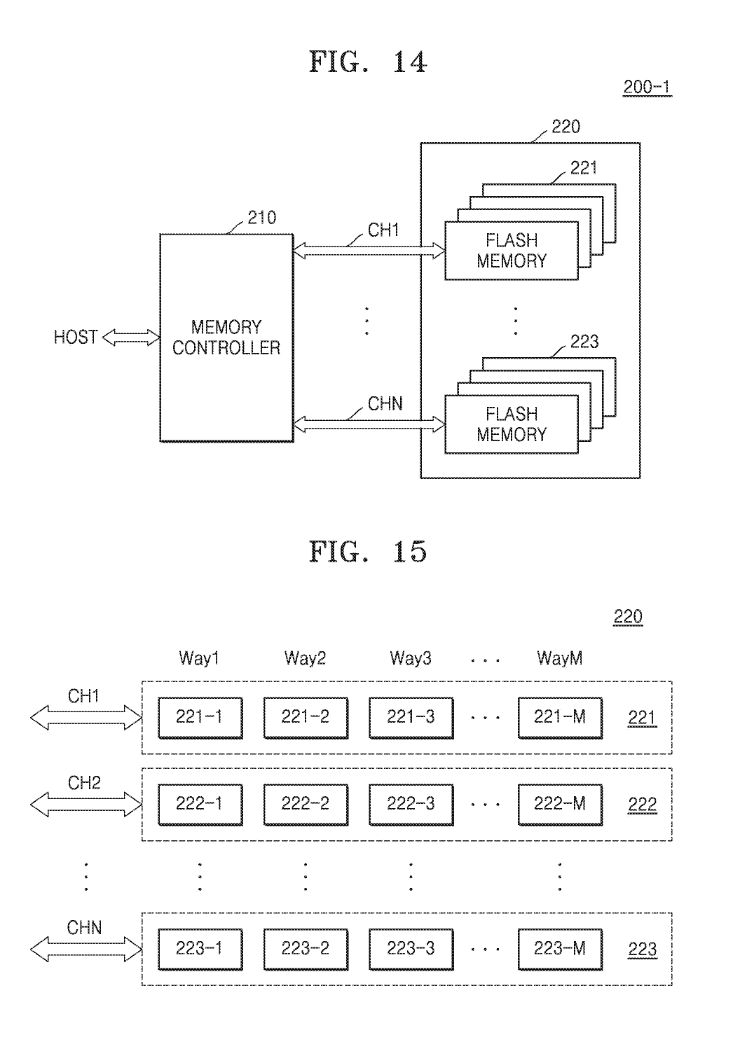

FIG. 14 is a block diagram of an SSD 200-1 forming the RAID storage system according to an exemplary embodiment of the disclosure.

As shown in FIG. 14, the SSD 200-1 includes a memory controller 210 and a memory device 220.

The memory controller 210 may control the memory device 220 based on a command transmitted from a host. In particular, the memory controller 210 provides addresses, commands, and control signals via a plurality of channels CH1 to CHN to control a programming (or writing) operation, a reading operation, and an erasing operation with respect to the memory device 220.

The memory device 220 may include one or more flash memory chips 221 and 223. As another example, the memory device 220 may include a phase change RAM (PRAM) chip, an FRAM chip, or an MRAM chip that is a non-volatile memory, as well as the flash memory chips.

The SSD 200-1 may include N channels (where N is a natural number), and each channel includes four flash memory chips in FIG. 14. The number of flash memory chips included in each of the channels may be set variously.

FIG. 15 is a diagram exemplarily showing a channel and a way in the SSD of FIG. 14.

A plurality of memory chips 221, 222, and 223 may be electrically connected to each of the channels CH1 to CHN. Each of the channels CH1 to CHN may be an independent bus, through which the commands, the addresses, and data may be transmitted to/from corresponding flash memory chips 221, 222, and 223. The flash memory chips connected to different channels may operate independently from each other. The plurality of flash memory chips 221, 222, and 223 connected to each of the channels CH1 to CHN may form a plurality of ways way1 to wayM. M flash memories may be connected to each of the M ways formed in the channels.

For example, the flash memory chips 221 may form M ways way1 to wayM in the first channel CH1. That is, flash memory chips 221-1 to 221-M may be respectively connected to the M ways way1 to wayM in the first channel CH1. The above relations between the flash memory chips, the channels, and the ways may be applied to the flash memory chips 222 and the flash memory chips 223.

A way is a unit for identifying the flash memory chips sharing an identical channel with each other. Each of flash memory chips may be identified according to a channel number and a way number. The flash memory chip that is to perform the request transmitted from the host may be determined by the logical address transmitted from the host.

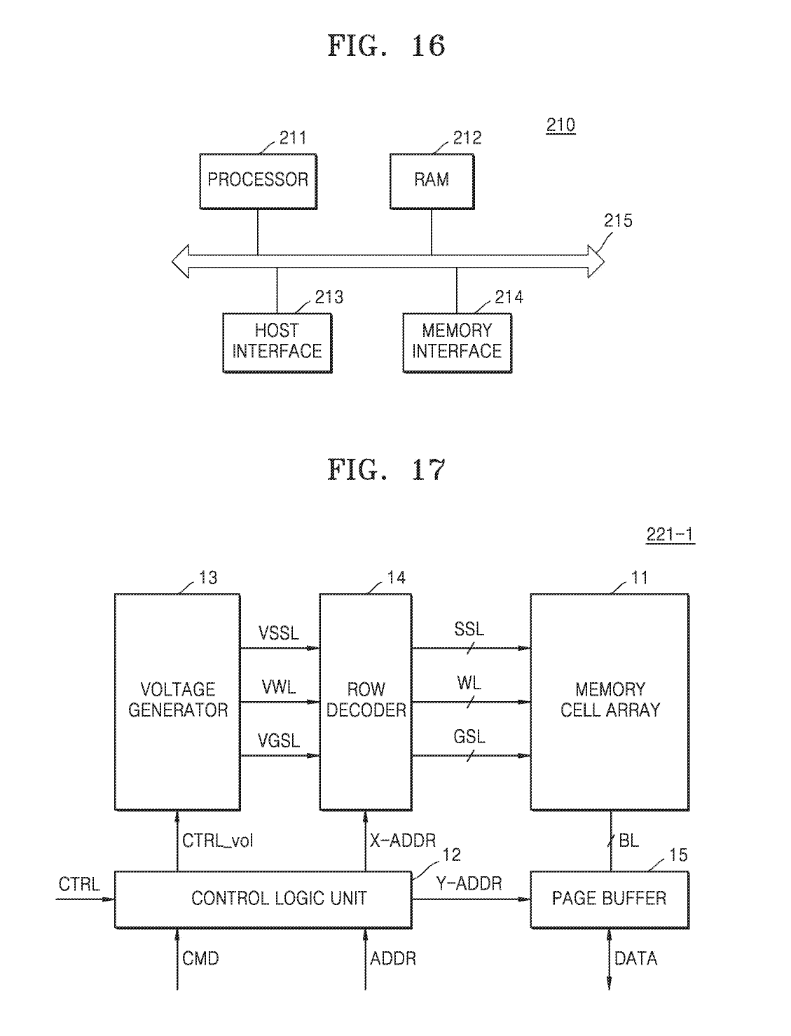

FIG. 16 is a diagram of the memory controller 210 of FIG. 15 in more detail.

As shown in FIG. 16, the memory controller 210 includes a processor 211, a RAM 212, a host interface 213, a memory interface 214, and a bus 215.

Elements of the memory controller 210 may be electrically connected to each other via the bus 215.

The processor 211 may control overall operations of the SSD 200-1 by using program codes and data stored in the RAM 212. When initializing the SSD 200-1, the processor 211 reads the program codes and data that are necessary for controlling operations of the SSD 200-1 from the memory device 220 and loads the read program codes and the data to the RAM 212.

The processor 211 may perform control operations corresponding to a command transmitted from the host by using the program codes and the data stored in the RAM 212. In particular, the processor 211 may execute a write command or a read command transmitted from the host. In addition, the processor 211 may control the SSD 200-1 to perform a page copying operation according to the garbage collection operation based on the command transmitted from the host.

The host interface 213 includes a data exchange protocol with the host connected to the memory controller 210, and performs interfaces between the memory controller 210 and the host. The host interface 213 may be, for example, an advanced technology attachment (ATA) interface, a serial advanced technology attachment (SATA) interface, a parallel advanced technology attachment (PATA) interface, a universal serial bus (USB) or a serial attached small computer system (SAS) interface, small computer system interface (SCSI), embedded multimedia card (eMMC) interface, or a universal flash storage (UFS), but is not limited thereto. The host interface 213 may receive a command, an address, and data from the host or may transmit data to the host according to the control of the processor 211.

The memory interface 214 is electrically connected to the memory device 220. The memory interface 214 may transmit the command, the address, and the data to the memory device 220 or receive the data from the memory device 220 according to the control of the processor 211. The memory interface 214 may be configured to support a NAND flash memory or a NOR flash memory. The memory interface 214 may perform software or hardware interleaving operations via the plurality of channels.

FIG. 17 is a block diagram of a flash memory chip 221-1 included in the memory device 220 of FIG. 15.

Referring to FIG. 17, the flash memory chip 221-1 may include a memory cell array 11, a control logic unit 12, a voltage generator 13, a row decoder 14, and a page buffer 15. Hereinafter, elements included in the flash memory chip 221-1 will be described.

The memory cell array 11 may be connected to one or more string selection lines SSL, a plurality of word lines WL, and one or more ground selection lines GSL, and may be also connected to a plurality of bit lines BL. The memory cell array 11 may include a plurality of memory cells MC arranged on regions where the plurality of word lines WL and the plurality of bit lines BL cross each other.

When an erasing voltage is applied to the memory cell array 11, the plurality of memory cells MC become erasing states, and when a programming voltage is applied to the memory cell array 11, the plurality of memory cells MC become programmed states. Here, each of the memory cells MC may have one of the erasing state and first to n-th programmed states (P1 to Pn) that are classified according to threshold voltages.

Here, n a natural number equal to or greater than 2. For example, if the memory cell MC is a two-bit level cell, n may be 3. In another example, if the memory cell MC is a three-bit level cell, n may be 7. In another example, if the memory cell MC is a four-bit level cell, n may be 15. As described above, the plurality of memory cells MC may include multi-level cells. However, one or more exemplary embodiments of the disclosure are not limited thereto, and the plurality of memory cells MC may include single level cells.

The control logic unit 12 may output various control signals for writing the data in the memory cell array 11 or reading the data from the memory cell array based on the command CMD, address ADDR, and the control signal CTRL transmitted from the memory controller 210. As such, the control logic unit 12 may control overall operations in the flash memory chip 221-1.

The various control signals output from the control logic unit 12 may be provided to the voltage generator 13, the row decoder 14, and the page buffer 15. In particular, the control logic unit 12 may provide the voltage generator 13 with a voltage control signal CTRL_vol, provide the row decoder 14 with a row address X_ADDR, and provide the page buffer 15 with a column address Y_ADDR.

The voltage generator 13 may generate various kinds of voltages for performing the programming operation, the reading operation, and the erasing operation with respect to the memory cell array 11 based on the voltage control signal CTRL_vol. In particular, the voltage generator 13 may generate a first driving voltage VWL for driving the plurality of word lines WL, a second driving voltage VSSL for driving the plurality of string selection lines SSL, and a third driving voltage VGSL for driving the plurality of ground selection lines GSL.

Here, the first driving voltage VWL may be a programming voltage (or writing voltage), a reading voltage, an erasing voltage, a pass voltage, or a program verification voltage. Also, the second driving voltage VSSL may be a string selection voltage, that is, an on-voltage or an off-voltage. Moreover, the third driving voltage VGSL may be a ground selection voltage, that is, an on-voltage or an off-voltage.

In the present exemplary embodiment, the voltage generator 13 may generate a program start voltage as the programming voltage based on the voltage control signal CTRL_vol, when the programming loop starts, that is, the number of times the programming loop is performed is 1. Also, the voltage generator 13 may generate a voltage that has increased from the program start voltage gradually by as much as a step voltage as the programming voltage, as the number of times the programming loops are performed increases.

The row decoder 14 is connected to the memory cell array 11 via the plurality of word lines WL, and may activate some of the plurality of word lines WL in response to the row address X_ADDR transmitted from the control logic unit 12. In particular, when performing a reading operation, the row decoder 14 applies the read voltage to a selected word line and applies the pass voltage to unselected word lines.

In addition, in the programming operation, the row decoder 14 may apply the programming voltage to the selected word line and may apply the pass voltage to unselected word lines. In the present exemplary embodiment, the row decoder 14 may apply the programming voltage to the selected word line and an additionally selected word line in at least one of the programming loops.

The page buffer 15 may be connected to the memory cell array 11 via the plurality of bit lines BL. In particular, in the reading operation, the page buffer 15 functions as a sense amplifier to output the data DATA stored in the memory cell array 11. In addition, in the programming operation, the page buffer 15 functions as a write driver to input the data DATA to be stored into the memory cell array 11.

FIG. 18 is a diagram showing an example of the memory cell array 11 shown in FIG. 17.

Referring to FIG. 18, the memory cell array 11 may be a flash memory cell array. Here, the memory cell array 11 includes a (where a is an integer equal to or greater than 2) memory blocks BLK1 to BLKa, each of the memory blocks BLK1 to BLKa includes b (where b is an integer equal to or greater than 2) pages PAGE1 to PAGEb, and each of the pages PAGE1 to PAGEb may include c (where c is an integer equal to or greater than 2) sectors SEC1 to SECc. In FIG. 18, the pages PAGE1 to PAGEb and the sectors SEC1 to SECc included in the memory block BLK1 are shown for convenience of description, but the other memory blocks BLK2 to BLKa may have the same structures as that of the memory block BLK1.

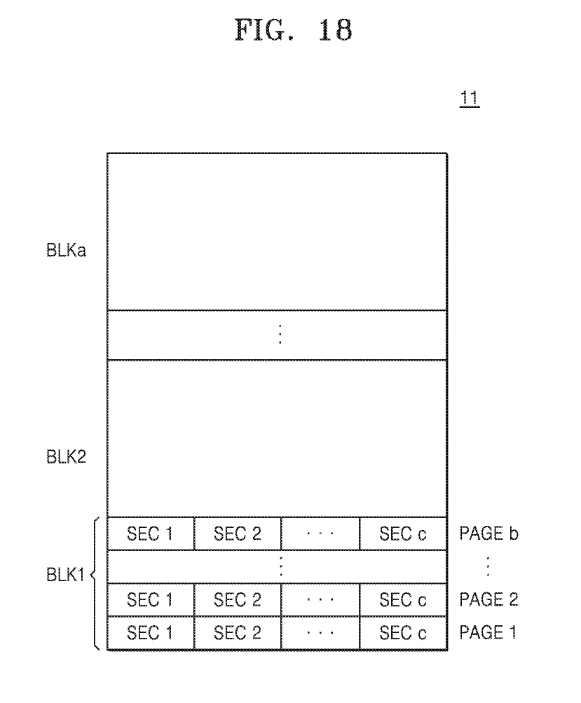

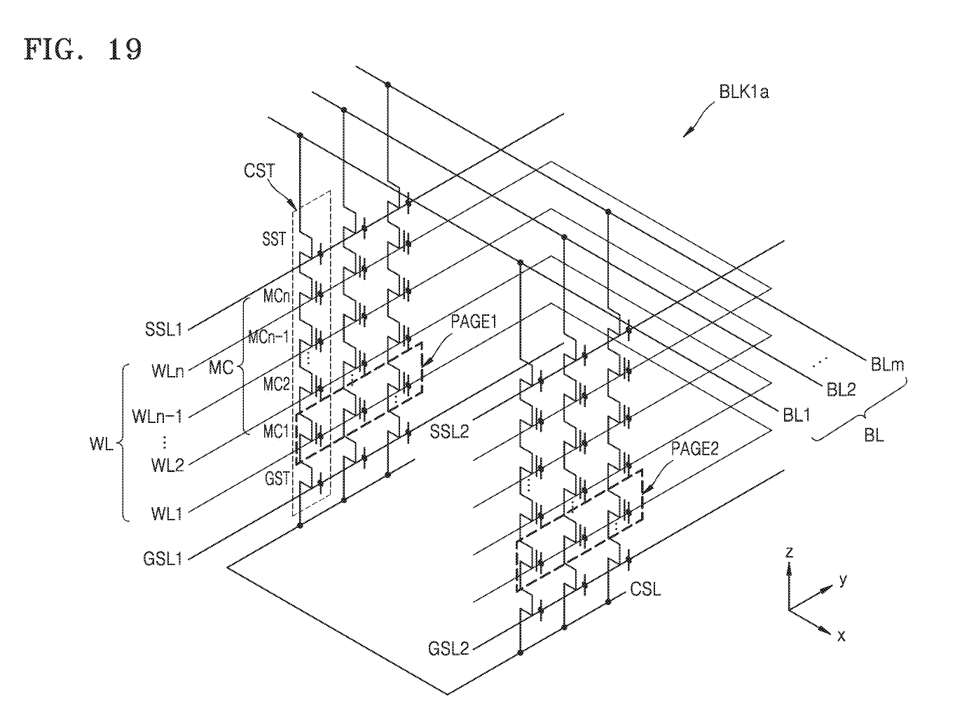

FIG. 19 is a circuit diagram of a first memory block BLK1a included in the memory cell array 11 of FIG. 18.

Referring to FIG. 19, the first memory block BLK1a may be a NAND flash memory of a vertical structure. In FIG. 19, a first direction will be referred to as an x direction, a second direction will be referred to as a y direction, and a third direction will be referred to as a z direction. However, one or more exemplary embodiments are not limited thereto, that is, the first to third directions may be changed.

The first memory block BLK1a may include a plurality of cell strings CST, a plurality of word lines WL, WL1-WLn, a plurality of bit lines BL, BL1-BLm, a plurality of ground selection lines GSL1 and GSL2, a plurality of string selection lines SSL1 and SSL2, and a common source line CSL. Here, the number of the cell strings CST, the number of word lines WL, the number of bit lines BL, the number of ground selection lines GSL1 and GSL2, and the number of string selection lines SSL1 and SSL2 may vary depending on the exemplary embodiment.

Each of the cell strings CST may include a string selection transistor SST serially connected between the bit line BL corresponding thereto and the common source line CSL, a plurality of memory cells MC, MC1-MCn, and a ground selection transistor GST. However, one or more exemplary embodiments are not limited thereto, and in another exemplary embodiment, each of the cell strings CST may further include at least one dummy cell. In another exemplary embodiment, each of the cell strings CST may include at least two string selection transistors SST or at least two ground selection transistors GST.

Also, each of the cell strings CST may extend in the third direction (z direction), and in particular, may extend on a substrate in a direction perpendicular to the substrate (z direction). Therefore, the memory block BLK1a including the cell strings CST may be referred to as a NAND flash memory of the vertical direction. As described above, when the cell strings CST extend on the substrate perpendicularly to the substrate (z direction), an integration degree of the memory cell array 11 may be increased.

The plurality of word lines WL extend in the first direction (x direction) and in the second direction (y direction), and each of the word lines WL may be connected to the memory cells MC corresponding thereto. Accordingly, the plurality of memory cells MC, which are arranged along the first and second directions (x and y directions) on the same layer to be adjacent to each other, may be connected to the same word line WL. In particular, each of the word lines WL is connected to a gate of the memory cell MC to control the memory cell MC. Here, the plurality of memory cells MC may store data, and may be programmed, read, or erased according to the control of the word line WL connected thereto.

The plurality of bit lines BL extend in the first direction (x direction), and may be connected to the string selection transistors SST. Accordingly, the plurality of string selection transistors SST, which are arranged along the first direction (x direction) to be adjacent to each other, may be connected to the same bit line BL. In particular, each of the bit lines BL may be connected to a drain of the string selection transistor SST.

The plurality of string selection lines SSL1 and SSL2 extend in the second direction (y direction), and may be connected to the string selection transistors SST. Accordingly, the plurality of string selection transistors SST arranged along the second direction (y direction) to be adjacent to each other may be connected to the same string selection line SSL1 or SSL2. In particular, each of the string selection lines SSL1 and SSL2 may be connected to a gate of the string selection transistor SST to control the string selection transistor SST.

A plurality of ground selection lines GSL1 and GSL2 extend in the second direction (y direction), and may be connected to the ground selection transistors GST. Accordingly, the plurality of ground selection transistors GST arranged along the second direction (y direction) may be connected to the same ground selection line GSL1 or GSL2. In particular, each of the ground selection lines GSL1 and GSL2 may be connected to a gate of the ground selection transistor GST to control the ground selection transistor GST.

Also, the ground selection transistors GST included in each of the cell strings CST may be commonly connected to the common source line CSL. In particular, the common source line CSL may be connected to sources of the ground selection transistors GST.

Here, the plurality of memory cells MC connected commonly to the same word line WL and the same string selection line SSL1 or SSL2 and arranged along the second direction (y direction) to be adjacent to each other may be referred to as a page PAGE. For example, the plurality of memory cells MC commonly connected to the first word line WL1 and the first string selection line SSL1 and arranged in the second direction (y direction) to be adjacent to each other may be referred to as a first page PAGE1. Also, the plurality of memory cells MC commonly connected to the first word line WL1 and the second string selection line SSL2 and arranged in the second direction (y direction) to be adjacent to each other may be referred to as a second page PAGE2.

In order to perform a programming operation on the memory cell MC, a voltage of 0V is applied to the bit line BL, an on-voltage may be applied to the string selection line SSL, and an off-voltage may be applied to the ground selection line GSL. The on-voltage may be equal to or greater than a threshold voltage of the string selection transistor SST so as to turn the string selection transistor SST on, and the off-voltage may be less than a threshold voltage of the ground selection transistors GST to turn the ground selection transistors GST off. Also, the programming voltage may be applied to a selected memory cell MC from among the plurality of memory cells MC, and the pass voltage may be applied to the other memory cells MC. When the programming voltage is applied to the memory cell MC, electric charges may be injected into the memory cells MC due to an F-N tunneling effect. The pass voltage may be greater than the threshold voltage of the memory cells MC.

In order to perform an erasing operation on the memory cell MC, an erasing voltage may be applied to bodies of the memory cells MC and a voltage of 0V may be applied to the word lines WL. Accordingly, the data stored in the memory cells MC may be erased at once.

FIG. 20 is a block diagram of a RAID storage system 3000 according to another exemplary embodiment of the disclosure.

As shown in FIG. 20, the RAID storage system 3000 may include a RAID controller 3100, a RAM 3200, a plurality of SSDs (SSD1 to SSDn) 3300-1 to 3300-n, and a bus 3400. Elements in the RAID storage system 3000 may be electrically connected to each other via the bus 3400.

The plurality of SSDs (SSD1 to SSDn) 3300-1 to 3300-n respectively include NVRAM cache regions 3300-1A to 3300-nA, and flash memory storage regions 3300-1B to 3300-nB.

The NVRAM cache regions 3300-1A to 3300-nA may be formed of PRAMs, FeRAMs, or MRAMs. As another example, the NVRAM cache regions 3300-1A to 3300-nA may be formed by DRAM or SRAM that is a volatile memory, to which electric power is supplied by using a battery or a capacitor. That is, if system power is turned off, the DRAM or the SRAM may be driven by using the battery or the capacitor so that data stored in the DRAM or the SRAM is moved to the storage device that is the non-volatile storage space. According to the above method, the data stored in the DRAM or the SRAM may be maintained even if the system power is turned off

The flash memory storage regions 3300-1B to 3300-nB are storage regions of the flash memory devices forming the SSD1 to SSDn 3300-1 to 3300-n.

A cache region for performing the stripe writing operation and a cache region to which an orphan page generated during the garbage collection operation may be allocated to each of the NVRAM cache regions 3300-1A to 3300nA.

For example, the valid pages in the memory blocks of the flash memory storage regions in the SSD1 to SSDn 3300-1 to 3300-n that form a victim stripe selected during the garbage collection operation may be stored in the NVRAM cache regions 3300-1A to 3300-nA.

For example, the RAID controller 3100 performs the writing operation in units of stripes by using the NVRAM cache regions 3300-1A to 3300-nA.

In addition, the RAID controller 3100 copies the valid pages written in the flash memory storage regions of the SSD1 to SSDn 3300-1 to 3300-n included in the victim stripe to the NVRAM cache regions of different SSDs.

The RAM 3200 is a volatile memory, for example, DRAM or SRAM. The RAM 3200 stores information or programming codes necessary for operating the RAID storage system 3000.

Accordingly, the RAM 3200 may store mapping table information. The mapping table information may include address mapping table information for converting logical addresses into physical addresses, and stripe mapping table information indicating information for the stripe grouping. The stripe mapping table information may include information for a valid page ratio in each of the stripes. Also, the mapping table information may include orphan mapping table information representing storage location information of the orphan data stored in the NVRAM cache regions 3300-1A to 3300-nA.

For example, the RAID controller 3100 reads the mapping table information from the NVRAM cache regions 3300-1A to 3300-nA or the flash memory storage regions 3300-1B to 3300-nB and loads the read mapping table information onto the RAM 3200. The RAID controller 3100 may perform the address conversion during the reading operation or the writing operation in the RAID storage system 3200 by using the address mapping table information loaded on the RAM 3200.

The RAID controller 3100 controls the SSDs 3300-1 to 3300-n based on a log-structured RAID environment. In particular, when the data written in the flash memory storage regions 3300-1B to 3300-nB is updated, the RAID controller 3100 configures the plurality of memory blocks, in which the data is written in the log format, and a memory block storing parity information for the data stored in the plurality of memory blocks as one stripe.

The RAID controller 3100 registers location information of the memory blocks in the flash memory storage regions 3300-1B to 3300-nB of the SSDs 3300-1 to 3300-n forming the stripe to the stripe mapping table.

The RAID controller 3100 may perform the address conversion process or the stripe grouping process by using the mapping table information stored in the RAM 3200. The RAID controller 3100 selects a victim stripe for performing the garbage collection by using the mapping table information. For example, the RAID controller 3100 determines a stripe having the lowest ratio of the valid pages from among the stripes that are grouped by using the stripe mapping table information, and then, selects the stripe as the victim stripe.

The RAID controller 3100 copies the valid pages in the memory blocks of the flash memory storage regions 3300-1B to 3300-nB in the SSD1 to SSDn 3300-1 to 3300-n configuring the victim stripe that is selected through the garbage collection operation, to the NVRAM cache regions 3300-1A to 3300-nA. The RAID controller 3100 performs the garbage collection controlling operation by using the data copied to the NVRAM cache regions 3300-1A to 3300-nA.

Then, the RAID controller 3100 may perform control operations for erasing the memory block of the flash memory storage regions 3300-1B to 3300-nB, which stores the parity information of the victim stripe, for copying the valid pages included in the victim stripe to the memory blocks that will form a new stripe in the flash memory storage regions 3300-1B to 3300-nB and for erasing the memory blocks of the victim stripe, which store the valid pages that are copied to the memory blocks configuring the new stripe.

The RAID controller 3100 calculates parity information for the data copied to the NVRAM cache regions 3300-1A to 3300-nA, and copies the calculated parity information to a memory block that will form a new stripe in the NVRAM cache region 3300-1A to 3300-nA.

The RAID controller 3100 registers the stripe grouping information for the configuration of the new stripe including the memory blocks, to which the valid pages included in the victim stripe are copied, and the memory block, to which the parity information is copied to the stripe mapping table. In addition, the RAID controller 3100 deletes stripe grouping information of the victim stripe from the stripe mapping table. Accordingly, the memory blocks included in the victim stripe become free blocks. Here, the free block denotes an empty memory block in which data is not stored.

After erasing the memory block storing the parity information included in the victim stripe during the garbage collection operation in the RAID storage system 3000, the valid pages written in the memory blocks included in the victim stripe are not protected by the parity information. That is, if there occurs a defect in some of the flash memory storage regions 3300-1B to 3300-nB in the SSD1 to SSDn 3300-1 to 3300-n, the valid pages written in the memory blocks of the flash memory storage region having the defect may be restored by using the data stored in the NVRAM cache region 3300-1A to 3300-nA.

When a request for reading the pages included in the victim stripe occurs during the garbage collection operation, the RAID controller 3100 reads the data of the pages that are requested to be read from the NVRAM cache regions 3300-1A to 3300-nA. The RAID controller 3100 may determine the NVRAM cache region, which stores the data requested to be read, in one SSD from among the SSD1 to SSDn 3300-1 to 3300-n by using the mapping table information.

For example, if a request for reading the page included in the victim stripe during the garbage collection operation is transmitted from an external host (not shown) to the RAID storage system 3000, the RAID controller 3100 searches for the NVRAM cache region storing the data of the page that is requested to be read in one SSD from among the SSD1 to SSDn 3300-1 to 3300-n. For example, if it is identified that the page that is requested to be read is stored in the NVRAM cache region 3300-2A in the SSD2 3300-2, the RAID controller 3100 reads the data from the NVRAM cache region 3300-2A in the SSD23300-2 and transmits the data to the host.

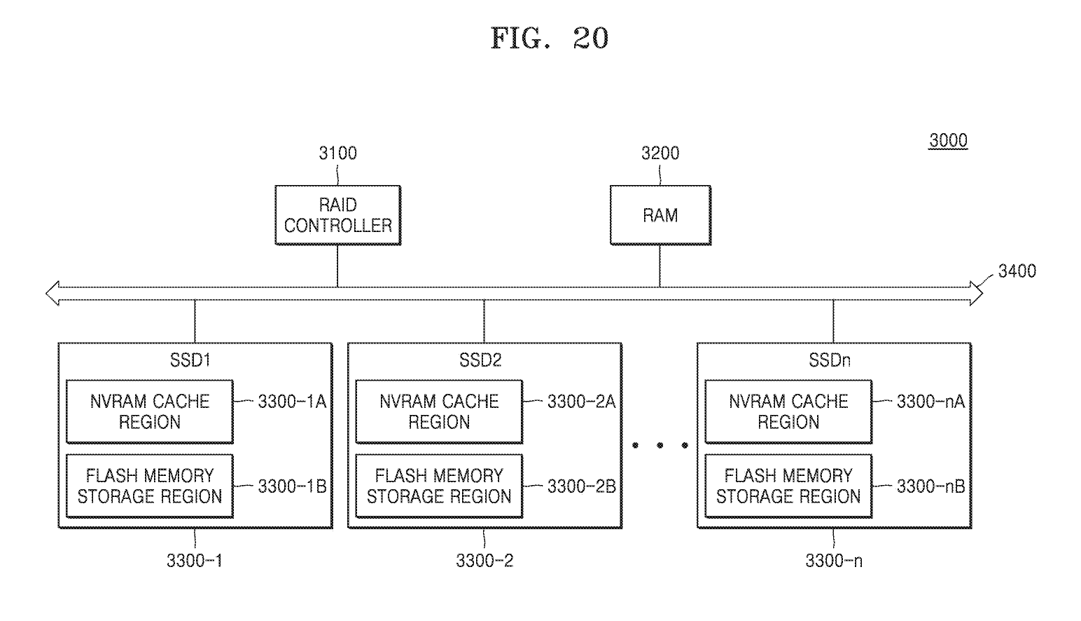

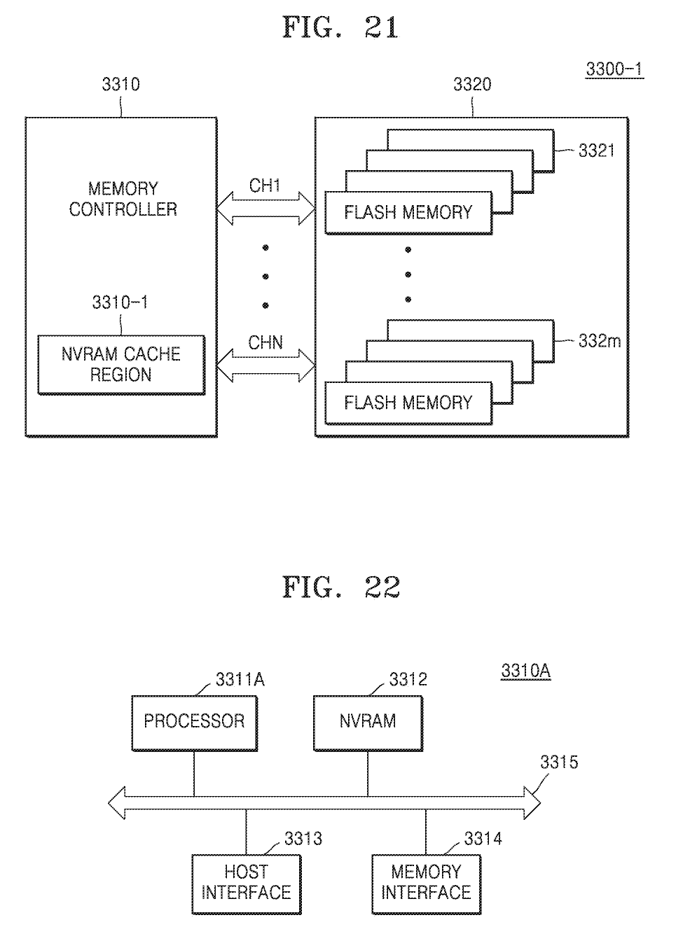

FIG. 21 is a block diagram of the SSD1 3300-1 of FIG. 20.

As shown in FIG. 21, the SSD 3300-1 includes a memory controller 3310 and a memory device 3320.

An NVRAM cache region 3310-1 is allocated to the memory controller 3310. The NVRAM cache region 3310-1 may be formed of PRAM or MRAM. As another example, the NVRAM 3310-1 may be formed by using the DRAM or SRAM that is a volatile memory, to which electric power is supplied by using a battery or a capacitor. That is, if system power is turned off, the DRAM or the SRAM may be driven by using the battery or the capacitor so that data stored in the DRAM or the SRAM is moved to the storage device that is the non-volatile storage space.

The memory controller 3310 may perform control operations on the memory device 3320 based on commands transmitted from a host. In particular, the memory controller 3310 provides addresses, commands, and control signals via a plurality of channels CH1 to CHN so as to control a programming (or writing operation), a reading operation, and an erasing operation with respect to the memory device 3320.

The memory device 3320 may include one or more flash memory chips 3321 to 332m. As another example, the memory device 3320 may include PRAM, FRAM, or MRAM that is a non-volatile memory, as well as the flash memory chips. The storage regions in the flash memory chips 3321 to 332m in the memory device 3320 become the flash memory storage regions 3310-1B.

The memory controller 3310 manages the NVRAM cache region 3310-1 based on the command transmitted from the RAID controller 3100 of the RAID storage system 3000. For example, the memory controller 3310 may write/read data of the orphan page generated during the garbage collection operation to/from the NVRAM cache region 3310-1 based on the command transmitted from the RAID controller 3100.

FIG. 22 is a block diagram of an example of the memory controller 3310 of FIG. 21.

As shown in FIG. 22, a memory controller 3310A may include a processor 3311A, an NVRAM 3312, a host interface 3313, a memory interface 3314, and a bus 3315. Elements in the memory controller 3310A may be electrically connected to each other via the bus 3315.

A cache region for storing data that is temporarily not protected by the parity information during the garbage collection operation may be allocated to the NVRAM 3312. In addition, the NVRAM 3312 may store the mapping table information used in the RAID storage system 3000. The mapping table information may include address mapping table information for converting logical addresses into physical addresses and stripe mapping table information representing information for the stripe grouping. The information for the stripe grouping may include information indicating memory blocks configuring each stripe. The stripe mapping information may include information for a valid page ratio in each of the stripes.

The processor 3311A may control overall operations of the SSD 3300-1 by using program codes and data stored in the NVRAM 3312. When the SSD 3300-1 is initialized, the processor 3311A may read the program codes and data necessary for controlling the operations performed in the SSD 3300-1 from the memory device 3320, and loads the program codes and the data onto the NVRAM 3312.

The processor 3311A may perform control operations corresponding to the commands transmitted from the host by using the program codes and the data stored in the NVRAM 3312. In particular, the processor 3311A may execute operations according to a write command or a read command transmitted from the host. In addition, the processor 3311A may control the SSD 3300-1 to perform a page copying operation according to the garbage collection operation, based on the command transmitted from the host.

The host interface 3313 may include a data exchange protocol with the host connected to the memory controller 3310 and operates as an interface between the memory controller 3310 and the host. The host interface 3313 may be, for example, an advanced technology attachment (ATA) interface, a serial advanced technology attachment (SATA) interface, a parallel advanced technology attachment (PATA) interface, a universal serial bus (USB) or a serial attached small computer system (SAS) interface, small computer system interface (SCSI), embedded multi-media card (eMMC) interface, or a universal flash storage (UFS), but is not limited thereto. The host interface 3313A may receive a command, an address, and data from the host or may transmit data to the host according to the control of the processor 3311A.

The memory interface 3314 is electrically connected to the memory device 3320. The memory interface 3314 may transmit the command, the address, and the data to the memory device 320 or may receive the data from the memory device 3320 according to the control of the processor 3311A. The memory interface 3314 may be configured to support a NAND flash memory or a NOR flash memory. The memory interface 3314 may be configured to perform software or hardware interleaving operations through the plurality of channels.

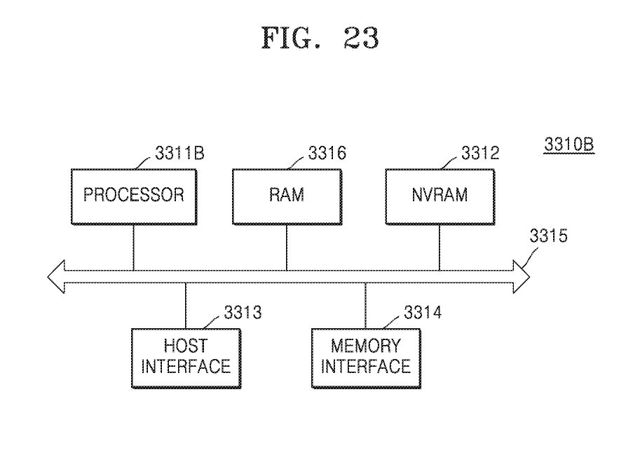

FIG. 23 is a block diagram showing another modified example of the memory controller 3310 of FIG. 21.

As shown in FIG. 23, a memory controller 3310B includes a processor 3311B, an NVRAM 3312, the host interface 3313, the memory interface 3314, the bus 3315, and a RAM 3316. Elements of the memory controller 3310B are electrically connected to each other via the bus 3315.

The memory controller 3310B of FIG. 23 additionally includes the RAM 3316, unlike the memory controller 3310A of FIG. 22. The host interface 3313 and the memory interface 3314 are described above with reference to FIG. 22, and thus, detailed descriptions thereof will not be repeated here.

The RAM 3316 is a volatile memory that may be formed of DRAM or SRAM. The RAM 3316 stores information or program codes necessary for operating the RAID storage system 3000.

For example, the RAM 3316 may store mapping table information. The mapping table information includes address mapping table information for converting a logical address to a physical address and stripe mapping table information representing information for stripe grouping. The stripe mapping table information may include valid page ratio information with respect to each stripe.

In addition, a cache region for storing data that is temporarily not protected by the parity information during the garbage collection operation may be allocated to the NVRAM 3312.

For example, the processor 3311B may read the mapping table information from the NVRAM 3312 and may load the mapping table information onto the RAM 3316. As another example, the processor 3311B may read the mapping table information from the memory device 3320 and load the read mapping table information onto the RAM 3316.

The processor 3311B may control overall operations of the SSD 3300-1 by using the program codes and data stored in the RAM 3316. When initializing the SSD 3300-1, the processor 3311B reads the program codes and data stored in the memory device 3320 or the NVRAM 3312 for controlling the operations performed in the SSD 3300-1 and load the program codes and data to the RAM 3316.

The processor 3311B may perform the control operations corresponding to commands transmitted from the host, by using the program codes and data stored in the RAM 3316. In particular, the processor 3311B may execute a write command or a read command transmitted from the host. Also, the processor 3311B may control the SSD 3300-1 to perform a page copy operation according to the garbage collection operation based on the command transmitted from the host.

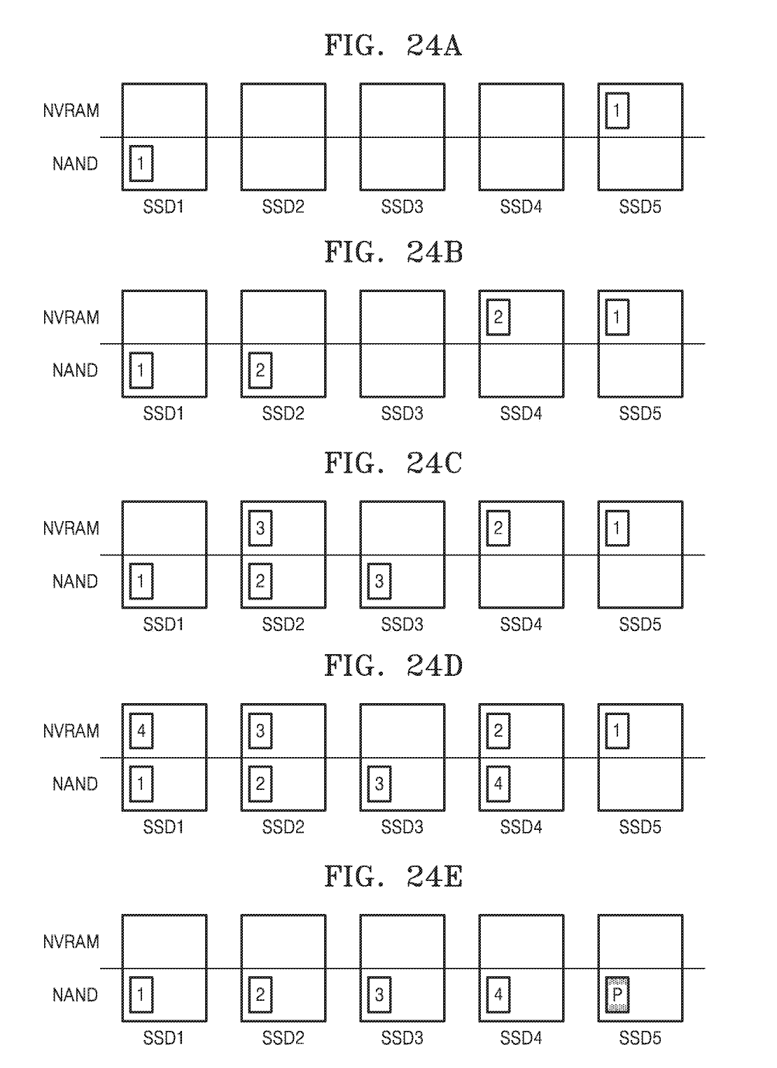

FIGS. 24A to 24E are conceptual diagrams illustrating a stripe writing operation in the RAID storage system 3000 of FIG. 20.

FIGS. 24A to 24E show an example of forming the RAID storage system 3000 by using five SSDs.

When a write request occurs, the processor 3311A or 3311B writes data corresponding to one memory block respectively in the flash memory storage region NAND of SSD1 to SSD5, and the cache region of the NVRAM. For example, it is determined that the flash memory storage region (NAND) and the NVRAM cache region are included in different SSDs from each other. Referring to FIG. 24A, the data D1 corresponding to an initial one memory block is written to both flash memory storage region (NAND) of the SSD1 and the NVRAM cache region of the SSD5.

Referring to FIG. 24B, the processor 3311A or 3311B writes data corresponding to a second memory block respectively to both a flash memory storage region (NAND) of the SSD2 and an NVRAM cache region of the SSD4.

Referring to FIG. 24C, the processor 3311A or 3311B writes data D3 corresponding to a third memory block respectively to both a flash memory storage region (NAND) of the SSD3 and an NVRAM cache region of the SSD2.

Referring to FIG. 24D, the processor 3311A or 3311B writes data D4 corresponding to a fourth memory block respectively to both a flash memory storage region (NAND) of the SSD4 and an NVRAM cache region of the SSD1.

Next, the processor 3311A or 3311B calculates parity information of the data D1 to D4 stored in the NVRAM cache regions of the SSD1 to SSD5, and then, writes the parity information in the flash memory storage region (NAND) of the SSD5. After that, the processor 3311A or 3311B flushes the data stored in the NVRAM cache regions. The data storage states, after the above processes are performed, are shown in FIG. 24E.

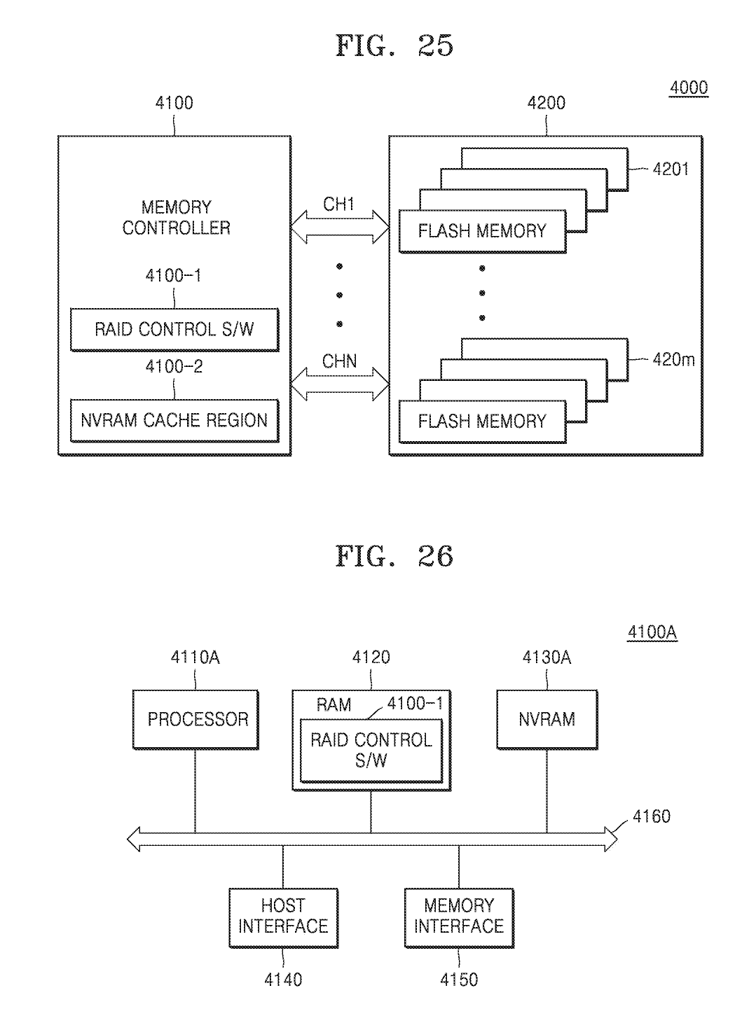

FIG. 25 is a diagram of a RAID storage system 4000 according to another exemplary embodiment of the disclosure.

As shown in FIG. 25, the RAID storage system 4000 includes a memory controller 4100 and a memory device 4200. Referring to FIG. 25, the RAID storage system 4000 includes a single SSD.

The memory device 4200 may include one or more flash memory chips 4201, . . . , 420m. As another example, the memory device 4200 may include a PRAM, an FRAM, or an MRAM chip that are the non-volatile memories, as well as the flash memory chips.

The memory controller 4100 stores RAID control software 4100-1, and an NVRAM cache region 4100-2 is allocated to the memory controller 4100.

The NVRAM cache region 4100-2 may be formed of PRAM, FeRAM, or MRAM. As another example, the NVRAM cache region 4100-2 may be formed by DRAM or SRAM that is a volatile memory, to which electric power is supplied by using a battery or a capacitor. That is, if system power is turned off, the DRAM or the SRAM may be driven by using the battery or the capacitor so that data stored in the DRAM or the SRAM is moved to the storage device that is the non-volatile storage space, so that the data is maintained.

The memory controller 4100 controls the RAID storage system 4000 to perform the stripe writing operation in units of channels or units of ways based on a log-structured RAID environment, by using the RAID control software 4100-1.

The memory controller 4100 provides addresses, commands, and control signals via a plurality of channels CH1 to CHN to control programming (or writing), reading, and erasing operations with respect to the memory device 4200.

The memory controller 4100 performs a control operation to copy valid pages of the memory device 4200, which are included in a victim stripe for a garbage collection, to the NVRAM cache region 4100-2 and performs the garbage collection operation by using the data copied to the NVRAM cache region 4100-2.

The memory controller 4100 performs control operations for erasing the memory block storing the parity information included in the victim stripe, for copying the valid pages included in the victim stripe to memory blocks for configuring a new stripe, and erasing the memory block of the victim stripe, which stores the valid pages copied to the memory block for configuring the new stripe.

The memory controller 4100 calculates parity information for orphan data copied to the NVRAM cache region 4100-2 and copies the calculated parity information to the memory block for configuring the new stripe.

The memory controller 4100 registers stripe grouping information for configuration of the new stripe to the stripe mapping table, with respect to the memory blocks to which the valid pages included in the victim stripe are copied, and the memory block to which the parity information is copied. In addition, the RAID controller 4100 deletes the stripe grouping information for the victim stripe from the stripe mapping table. Accordingly, the memory blocks included in the victim stripe become free blocks.

When a request for reading a page included in the victim stripe during the garbage collection operation is received, the memory controller 4100 reads the data of the page that is requested to be read from the NVRAM cache region 4100-2.

FIG. 26 is a block diagram of a memory controller 4100A according to a modified example of the memory controller 4100 of FIG. 25.

As shown in FIG. 26, the memory controller 4100A includes a processor 4110A, a RAM 4120, an NVRAM 4130A, a host interface 4140, a memory interface 4150, and a bus 4160. Elements of the memory controller 4100A are electrically connected to each other via the bus 4160.

The host interface 4140 and the memory interface 4150 are substantially the same as the host interface 3313 and the memory interface 3314 shown in FIG. 22, and thus, detailed descriptions thereof will not be repeated.

The RAM 4120 is a volatile memory, and may include DRAM or SRAM. The RAM 4120 includes RAID control software 4100-1 and system data that are necessary for operating the RAID storage system 4000.

For example, the RAM 4120 may store mapping table information. The mapping table information includes address mapping table information for converting a logical address to a physical address and stripe mapping table information representing information for stripe grouping. The stripe mapping table information may include valid page ratio information with respect to each of the stripes that are grouped.

In addition, a cache region for storing data that is temporarily not protected by the parity information during the garbage collection operation may be allocated to the NVRAM 4130A.

The processor 4110A may control overall operations of the RAID storage system 4000 by using the program codes and data stored in the RAM 4120. When initializing the RAID storage system 4000, the processor 4110A reads the program codes and data stored in the memory device 4200 or the NVRAM 4130A for controlling the operations performed in the RAID storage system 4000 and loads the program codes and data to the RAM 4120.

The processor 4110A may perform control operations corresponding to commands transmitted from the host by using the program codes and data stored in the RAM 4120. For example, the processor 4110A may execute a write command or a read command transmitted from the host. Also, the processor 4110A may control the RAID storage system 4000 to perform a page copy operation according to the garbage collection operation, based on the command transmitted from the host.

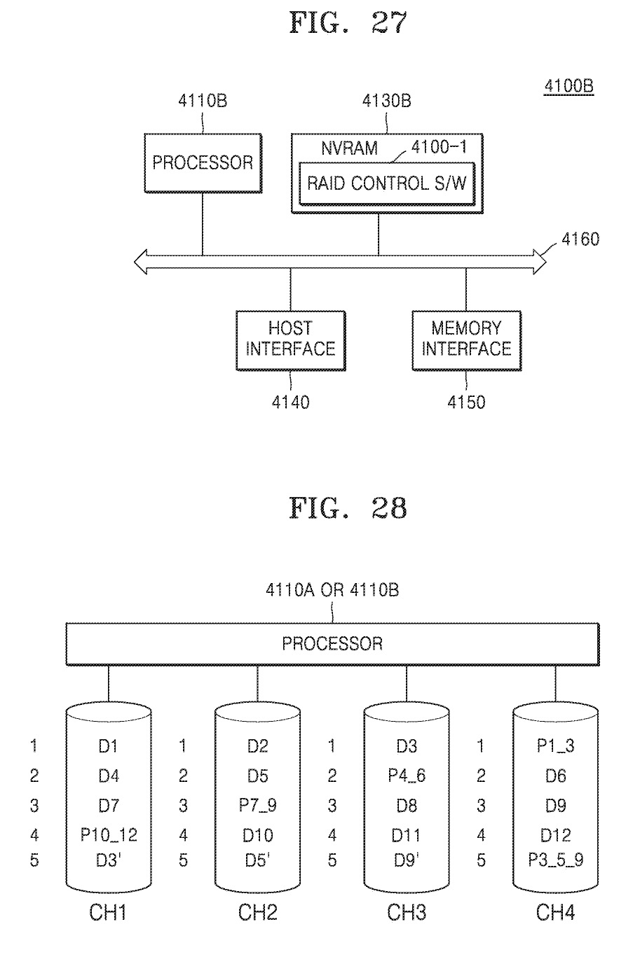

FIG. 27 is a diagram showing another modified example of the memory controller of FIG. 25.

As shown in FIG. 27, the memory controller 4100B includes a processor 4110B, an NVRAM 4130B, the host interface 4140, the memory interface 4150, and the bus 4160. Elements of the memory controller 4100B are electrically connected to each other via the bus 4160.

The NVRAM 4130B stores the RAID control software 4100-1 and system data that are necessary for operating the RAID storage system 4000.

A cache region for storing data that is temporarily not protected by the parity information during the garbage collection operation may be allocated to the NVRAM 4130B. In addition, the NVRAM 4130B may store mapping table information used in the RAID storage system 4000. The mapping table information includes address mapping table information for converting a logical address to a physical address and stripe mapping table information representing information for stripe grouping. The information for stripe grouping may include information indicating memory blocks forming each of the stripes. The stripe mapping table information may include valid page ratio information with respect to each of the stripes that are grouped.

The processor 4110B may control overall operations of the RAID storage system 4000 by using the program codes and data stored in the NVRAM 4130B. When initializing the RAID storage system 4000, the processor 4110B reads the program codes and data stored in the memory device 4200 for controlling the operations performed in the RAID storage system 4000 and loads the program codes and data to the NVRAM 4130B.

The processor 4110B may perform control operations corresponding to commands transmitted from the host by using the program codes and data stored in the NVRAM 4130B. For example, the processor 4110B may execute a write command or a read command transmitted from the host. Also, the processor 4110B may control the RAID storage system 4000 to perform a page copy operation according to the garbage collection operation, based on the command transmitted from the host.

FIG. 28 is a diagram showing an example of forming a stripe in the RAID storage system 4000 of FIG. 25.

FIG. 28 shows an example of forming a stripe by using memory blocks of flash memory chips included in a channel 1 CH1 to a channel 4 CH4 performed by the processor 4110A or 4110B. That is, the memory blocks of the flash memory chips included in the channels CH1 to CH4 form one stripe.

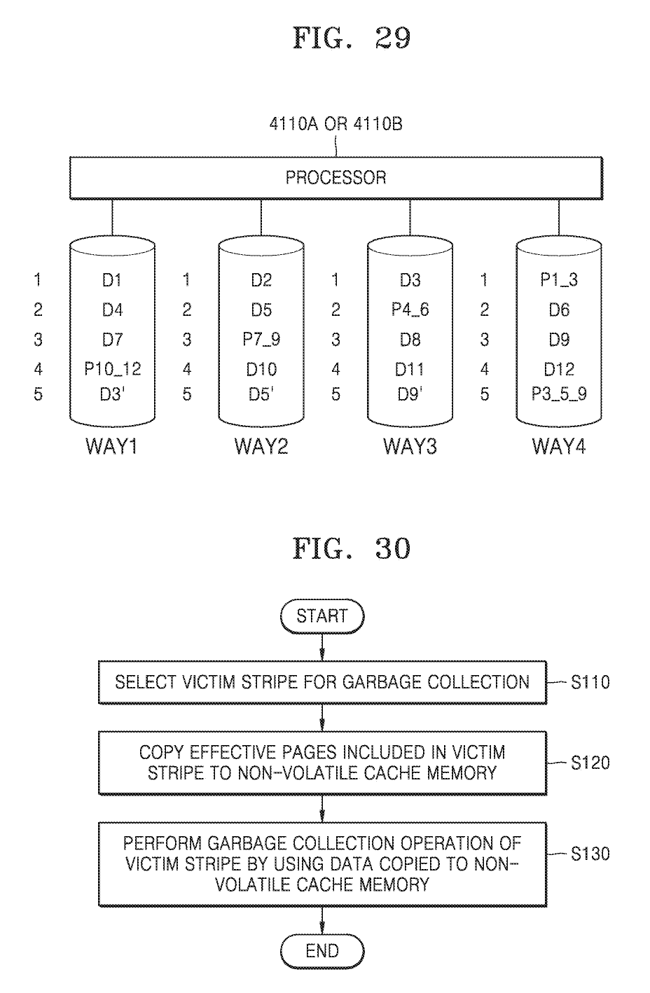

FIG. 29 is a diagram showing another example of forming a stripe in the RAID storage system of FIG. 25.

FIG. 29 shows an example of forming the stripe by using memory blocks of flash memory chips included in a way 1 WAY1 to a way 4 WAY4 performed by the processor 4110A or 4110B. That is, the memory blocks of the flash memory chips included in the ways WAY1 to WAY4 form one stripe.

Next, the garbage collection operating method performed in the RAID storage systems of various kinds illustrated in FIGS. 1 to 4, and FIG. 20 or FIG. 25 according to exemplary embodiments of the disclosure will be described with reference to FIGS. 30 to FIG. 33.

FIG. 30 is a flowchart illustrating the garbage collection operating method according to an exemplary embodiment of the disclosure.

First, the RAID storage system selects a victim stripe for the garbage collection operation (S110). For example, a stripe having the lowest valid page to all pages ratio from among a plurality of stripes that are grouped may be selected as the victim stripe.

Next, the RAID storage system copies valid pages included in the victim stripe to a non-volatile cache memory (S120). For example, the RAID storage system reads the valid pages included in memory blocks forming the victim stripe and writes the valid pages in an orphan cache region of the non-volatile cache memory.

Next, the RAID storage system performs a garbage collection operation on the victim stripe by using the data copied to the non-volatile cache memory (S130). For example, the RAID storage system performs operations of copying the valid pages to memory blocks that form a new stripe by using data stored in the memory block included in the victim stripe or the data copied to the non-volatile cache memory, erasing the memory blocks included in the victim stripe, calculating parity information for the data copied to the non-volatile cache memory, and writing the calculated parity information in the memory block for forming the new stripe.

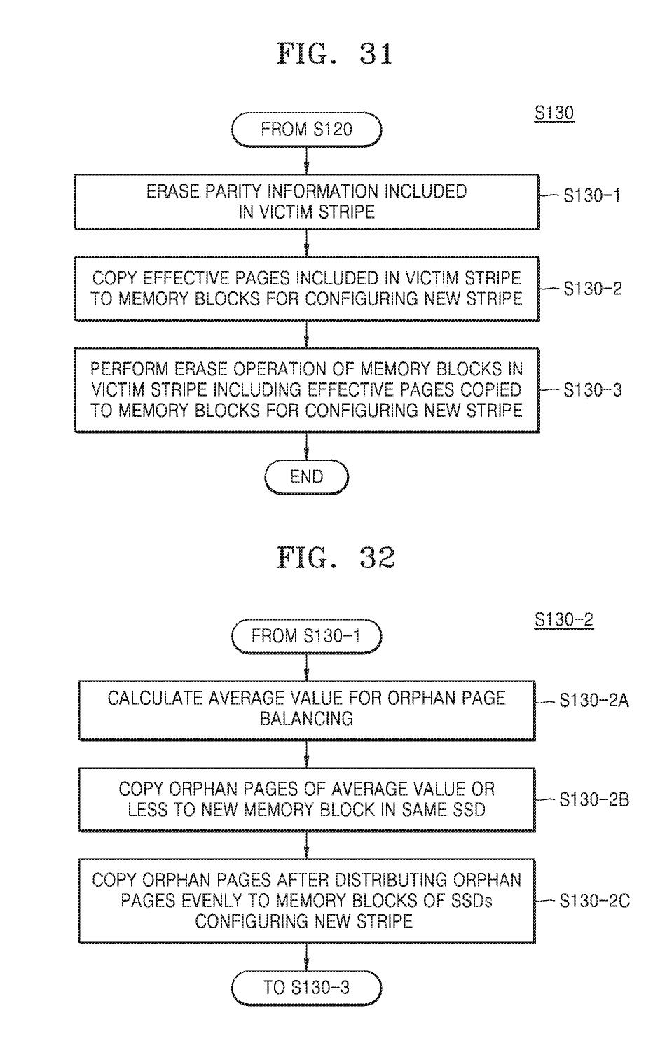

FIG. 31 is a flowchart illustrating the garbage collection operation S130 of FIG. 30 in more detail.

The RAID storage system erases the parity information included in the victim stripe (S130-1). After erasing the parity information, the data of the valid pages stored in the memory blocks of the victim stripe and the data copied to the non-volatile cache memory become the orphan data. Here, the orphan data denotes data of a page that is not protected by the parity information.

Next, the RAID storage system copies the valid pages included in the victim stripe to memory blocks that are to form a new stripe (S130-2). For example, the RAID storage system may copy the valid pages to the memory block for forming the new stripe, wherein the memory block is included in the same SSD as that of storing the valid pages. As another example, the RAID storage system may evenly distribute the valid pages included in the victim stripe to the memory blocks for forming the new stripe.

Next, the RAID storage system erases the memory block of the victim stripe, which includes the valid pages that are copied to the memory block for forming the new stripe (S130-3). The memory block that is erased becomes a free block.

When performing operations S130-2 and S130-3 sequentially with respect to the memory blocks included in the victim stripe, all the memory blocks included in the victim stripe become free blocks.

FIG. 32 is a flowchart illustrating operation S130-2 for copying the valid pages to the memory block shown in FIG. 31 in more detail.

The RAID storage system calculates an average value for orphan page balancing (S130-2A). For example, the RAID storage system may calculate the average value by dividing the total number of valid pages included in the victim stripe by the number of memory blocks, except for the memory block including the parity information, from among the memory blocks forming the stripe.

Next, the RAID storage system copies the orphan pages, the number of which is equal to or less than the average value, to new memory blocks of the same SSD (S130-2B). Here, the memory blocks denote memory blocks that will form the new stripe.

Next, the RAID storage system distributes and copies the orphan pages evenly to the memory blocks of the SSDs that will form the new stripe (S130-2C).

An example of a result of performing operation S130-2 for copying the valid pages to the memory blocks is shown in FIG. 13B.

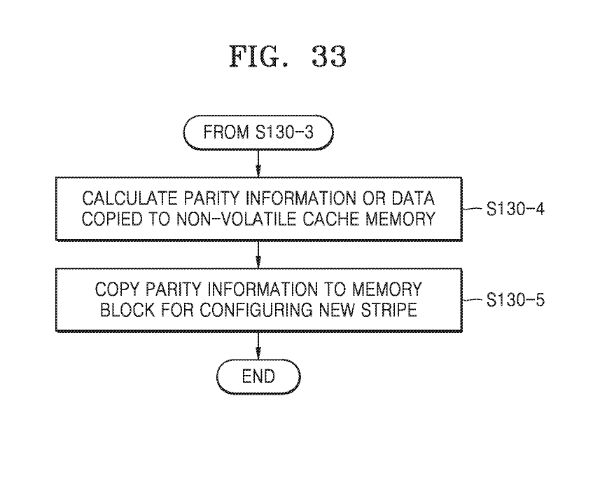

FIG. 33 is a flowchart illustrating operation S130 for performing the garbage collection operation shown in FIG. 30 in more detail according to another exemplary embodiment.

After performing operation S130-3 of FIG. 31, the RAID storage system calculates parity information for the data copied to the non-volatile cache memory (S130-4).

In addition, the RAID storage system copies the calculated parity information to a memory block for forming the new stripe (S130-5). After performing the above operations, the RAID storage system may flush the orphan data stored in the non-volatile cache memory.

In addition, the RAID storage system applied to exemplary embodiments of the disclosure may be mounted on various kinds of packages. For example, the system according to exemplary embodiments of the disclosure may be mounted by using packages such as Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic MetricQuad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), and Wafer-Level Processed Stack Package (WSP).

While the disclosure has been particularly shown and described with reference to exemplary embodiments thereof, it will be understood that various changes in form and details may be made therein without departing from the spirit and scope of the following claims.

1. A method, executed by a processor, of performing a garbage collection operation, the method comprising:
selecting a victim stripe for performing the garbage collection in a redundant array of independent disks (RAID) storage system based on a ratio of valid pages;
copying valid pages included in the victim stripe to a non-volatile cache memory; and
performing the garbage collection with respect to the victim stripe by using data copied to the non-volatile cache memory.

2. The method of claim 1, wherein the selecting of the victim stripe is performed based on a lower order of valid page ratios in stripes.

3. The method of claim 1, wherein the copying of the valid pages to the non-volatile cache memory comprises copying valid pages included in memory blocks of a solid state drive (SSD) forming the victim stripe that is selected in a log-structured RAID storage system based on SSDs, to the non-volatile cache memory.

4. The method of claim 1, wherein the performing of the garbage collection comprises:
erasing parity information included in the victim stripe;
copying the valid pages included in the victim stripe to memory blocks that are to form a new stripe; and
performing an erasing operation on memory blocks of the victim stripe, which store the valid pages that have been copied.

5. The method of claim 4, wherein the memory blocks that are to form the new stripe are allocated as storage regions, to which the valid pages included in the victim stripe for the garbage collection are copied.

6. The method of claim 4, wherein the copying of the valid pages to the memory blocks to form the new stripe comprises copying the valid pages to a memory block within the new stripe in a solid state drive (SSD) that includes the valid pages of the victim stripe.

7. The method of claim 4, wherein the copying of the valid pages to the memory blocks to form the new stripe comprises distributing the valid pages included in the victim stripe evenly to the memory blocks that are to form the new stripe.

8. The method of claim 4, wherein the copying of the valid pages to the memory block to form the new stripe comprises:
calculating an average value of the valid pages of the victim stripe by dividing a total number of the valid pages included in the victim stripe by the number of memory blocks of the victim stripe, except for a memory block storing the parity information of the victim stripe;
copying the valid pages in each of the memory blocks configuring the victim stripe to new memory blocks of a solid state drive (SSD) that is the same as the SSD including the valid pages, in a range of less than or equal to the average value; and
copying remaining valid pages in the victim stripe to a memory block for forming the new stripe so that the valid pages may be evenly stored in memory blocks of SSDs for forming the new stripe.

9. The method of claim 4, wherein the performing of the garbage collection comprises:
calculating parity information for data copied to the non-volatile cache memory; and
copying the parity information to a memory block that is to form the new stripe.

10. The method of claim 1, wherein if a request for reading a valid page included in the victim stripe is transmitted to the RAID storage system during the garbage collection, the valid page is read from the non-volatile cache memory.

11. A redundant array of independent disks (RAID) storage system comprising:
a plurality of storage devices, each comprising memory blocks for storing data;
a non-volatile random access memory (NVRAM); and
a RAID controller for controlling the plurality of storage devices based on a log-structured RAID environment,
wherein the RAID controller performs a control operation for copying valid pages of the plurality of storage devices included in a victim stripe for garbage collection to the NVRAM, and performs a garbage collection control operation by using data copied to the NVRAM.

12. The RAID storage system of claim 11, wherein the plurality of storage devices comprises a plurality of solid state drives (SSDs).

13. The RAID storage system of claim 11, wherein the NVRAM comprises:
a first cache region for storing data to be written in the plurality of storage devices in units of stripes; and
a second cache region to which the valid pages of the plurality of storage devices included in the victim stripe are copied.

14. The RAID storage system of claim 11, wherein the garbage collection control operation comprises a control operation for erasing a memory block storing parity information included in the victim stripe, a control operation for copying the valid pages included in the victim stripe to memory blocks that are to form a new stripe, and a control operation for erasing memory blocks of the victim stripe from which the valid pages were copied to the memory blocks that are to form the new stripe.

15. The RAID storage system of claim 14, wherein the garbage collection control operation further comprises a control operation of calculating parity information for data copied to the NVRAM and copying the parity information to a memory block for configuring the new stripe.

16. A method of recovering pages constituting a unit stripe of memory, the method executed by a processor of a memory controller in a log-structured storage system of a redundant array of independent disks (RAID) storage system and the method comprising:
selecting, among multiple stripes that each comprises first and second memory blocks, a stripe having an invalid pages-to-total pages ratio exceeding a threshold value;
copying valid pages of the selected stripe to a nonvolatile cache; and
erasing data stored in invalid pages and the valid pages of the selected stripe.

17. The method of claim 16, further comprising:
receiving, from a host device, a request for a particular valid page of the selected stripe;
retrieving the copy of the particular page from the nonvolatile cache; and
communicating the retrieved copy of the particular page to the host device.

18. The method of claim 16, further comprising copying the valid pages of the selected stripe to first and second memory blocks of another stripe whose pages are erased.

19. The method of claim 18, further comprising:
for each valid page within the first block and an associated page within the second block of the other stripe, generating a page of parity information and storing the generated page of parity information in a third memory block of the other stripe; and
registering the new locations of the valid pages copied to the other stripe and their associated parity information within an address mapping registry.

20. The method of claim 19, further comprising:
upon receiving, from a host device, a request for a particular valid page of the selected stripe prior to registering the new locations of the valid pages copied to the other stripe and their associated parity information within the address mapping registry:
retrieving the copy of the particular page from the nonvolatile cache, and
communicating the retrieved copy of the particular page to the host device; and
upon receiving, from the host device, a request for the particular valid page of the selected stripe after registering the new locations of the valid pages copied to the other stripe and their associated parity information within the address mapping registry:
retrieving the particular page from the other stripe using location information for the particular page stored within the address mapping registry, and
communicating the particular page retrieved from the other stripe to the host device.

21-27. (canceled)
